(19) United States
(12) Patent Application Publication
(10) Pub. No.: US 2013/0227460 A1
(43) Pub. Date: Aug. 29, 2013

(54) DATA ENTRY SYSTEM CONTROLLERS FOR RECEIVING USER INPUT LINE TRACES RELATIVE TO USER INTERFACES TO DETERMINE ORDERED ACTIONS, AND RELATED SYSTEMS AND METHODS

(71) Applicants: Bjorn David Jawerth, Morrisville, NC (US); Louise Marie Jawerth, Cambridge, MA (US); Stefan Muenster, Erlanger (DE); Arif Hikmet Oktay, Cary, NC (US)

(72) Inventors: Bjorn David Jawerth, Morrisville, NC (US); Louise Marie Jawerth, Cambridge, MA (US); Stefan Muenster, Erlanger (DE); Arif Hikmet Oktay, Cary, NC (US)

(21) Appl. No.: 13/779,711

(22) Filed: Feb. 27, 2013

Related U.S. Application Data
(60) Provisional application No. 61/603,785, filed on Feb. 27, 2012.
(60) Provisional application No. 61/611,283, filed on Mar. 15, 2012.
(60) Provisional application No. 61/635,649, filed on Apr. 19, 2012.
(60) Provisional application No. 61/641,572, filed on May 2, 2012.
(60) Provisional application No. 61/693,828, filed on Aug. 28, 2012.

(51) Int. Cl. G06F 3/0488

(52) U.S. Cl. CPC G06F 3/04886
USPC 715/773

(57) ABSTRACT

Embodiments disclosed herein include data entry controllers for receiving user input line traces relative to user interfaces to determined ordered actions. Related systems and methods are also disclosed. In one embodiment, a data entry system controller is provided and configured to receive coordinates representing locations of user input relative to a user interface. The user interface comprises a line interface comprising a plurality of ordered line segments. Each of the plurality of line segments represents at least one action visually represented by at least one label. The data entry system controller is further configured to determine a line trace between a plurality of coordinates crossing at least two line segments of the plurality of line segments. The data entry system controller is further configured to determine an ordered plurality of actions based on the ordered crossings of the line trace with the plurality of line segments of the line interface. In this manner, a user can provide data input, such as data input representative of keyboard input as a non-limiting example, by providing line traces that cross the line segments of the line interface according to the desired chosen actions by the user.

### PRIORITY APPLICATIONS

The present application claims priority to U.S. Provisional Patent Application Ser. No. 61/603,785 filed on Feb. 27, 2012 and entitled “DATA ENTRY SYSTEM CONTROLLERS FOR RECEIVING LINE TRACE INPUT ON KEYBOARDS OF TOUCH-SENSITIVE SURFACES, AND RELATED SYSTEMS AND METHODS,” which is hereby incorporated herein by reference in its entirety.

The present application claims priority to U.S. Provisional Patent Application Ser. No. 61/611,283 filed on Mar. 15, 2012 and entitled “DATA ENTRY SYSTEM CONTROLLERS FOR RECEIVING LINE TRACE INPUT ON KEYBOARDS OF TOUCH-SENSITIVE SURFACES, AND RELATED SYSTEMS AND METHODS,” which is hereby incorporated herein by reference in its entirety.

The present application claims priority to U.S. Provisional Patent Application Ser. No. 61/635,649 filed on Apr. 19, 2012 and entitled “DATA ENTRY SYSTEM CONTROLLERS FOR RECEIVING LINE TRACE INPUT ON KEYBOARDS OF TOUCH-SENSITIVE SURFACES, AND RELATED SYSTEMS AND METHODS,” which is hereby incorporated herein by reference in its entirety.

The present application claims priority to U.S. Provisional Patent Application Ser. No. 61/641,572 filed on May 2, 2012 and entitled “DATA ENTRY SYSTEM CONTROLLERS FOR RECEIVING LINE TRACE INPUT ON KEYBOARDS OF TOUCH-SENSITIVE SURFACES, AND RELATED SYSTEMS AND METHODS,” which is hereby incorporated herein by reference in its entirety.

The present application claims priority to U.S. Provisional Patent Application Ser. No. 61/693,828 filed on Aug. 28, 2012 and entitled “DATA ENTRY SYSTEM CONTROLLERS FOR RECEIVING LINE TRACE INPUT ON KEYBOARDS OF TOUCH-SENSITIVE SURFACES, AND RELATED SYSTEMS AND METHODS,” which is hereby incorporated herein by reference in its entirety.

### FIELD OF THE DISCLOSURE

The technology of the disclosure relates generally to crossings-based line interfaces for data entry system controllers on touch-sensitive surfaces, or employing mid-air operations, and control of such line interfaces, and related systems and methods, and more specifically to data entry system controllers for receiving line trace inputs on touch-sensitive surfaces or through midair inputs.

### BACKGROUND

Efficient and accurate data entry on mobile devices can be difficult, due to the reduced data input area of a mobile device. Touch screens are capable of registering single-touch and multiple-touch events, and also display and receive typing on an on-screen keyboard (“virtual keyboard”). One limitation of typing on a virtual keyboard is the typical lack of tactile feedback. Another limitation of typing on a virtual keyboard is an intended typing style. For example, a virtual keyboard may rely on text entry by user using one finger on one hand while holding the device with the other. Alternatively, a user may use two thumbs to tap the virtual keys on the screen of the device, and to hold the device between the palms of the hands. Another limitation of virtual keyboards is that they typically require the input process and the visual feedback about the key presses to occur in close proximity; however, it is often desirable to enter data while following the input process remotely on a separate device. Yet another limitation of virtual keyboards is that implementation on small devices (such as watches and other “wearables”) is different since the key areas are too small, and the key labels are hidden by the operation of the keyboard. It would be useful to explore new data entry approaches that are efficient, intuitive, and easy to learn.

### SUMMARY OF THE DISCLOSURE

Embodiments disclosed herein include data entry controllers for receiving user input line traces relative to user interfaces to determined ordered actions. Related systems and methods are also disclosed. In this regard, in one embodiment, a data entry system controller is provided. The data entry system controller may be provided in any electronic device that has data entry. To allow the user to provide user input, the data entry system controller is configured to receive coordinates representing locations of user input relative to a user interface. In this regard, the user interface comprises a line interface. The line interface comprises a plurality of ordered line segments. Each of the plurality of line segments representing at least one action visually represented by at least one label. The data entry system controller is further configured to determine a line trace between a plurality of coordinates crossing at least two line segments of the plurality of line segments. For example, the of coordinates crossing at least two line segments of the plurality of line segments may be from user input on a touch-sensitive user interface, as a non-limiting example. Each of the plurality of coordinates representing a location of user input relative to the line interface. The data entry system controller is further configured to determine an ordered plurality of actions based on the ordered crossings of the line trace with the plurality of line segments of the line interface. The data entry system controller is further configured to determine at least one user feedback event based on the determined ordered plurality of actions. The data entry system controller is further configured to generate at least one user feedback event on a graphical user interface based on the executed ordered plurality of actions.

In this manner, a user can provide data input, such as data input representative of keyboard input as a non-limiting example, by providing line traces that cross the line segments of the line interface according to the desired chosen actions by the user. The user does not have to lift or interrupt their user input from the user interface. The line traces could be provided by the user on a touch-sensitive interface, crossing the line interface for desired actions, to generate the coordinates representing locations of user input relative to a user interface, to be converted into the actions. Also, as a another example, the line traces could be line traces in mid-air that are detected by a receiver and converted into coordinates about a line interface to provide the coordinates representing locations of user input relative to a user interface, to be converted into the actions.

In another embodiment, a method of generating user feedback events on a graphical user interface is provided. The method comprises receiving coordinates at a data entry system controller representing locations of user input relative to a user interface. The user interface comprising a line interface comprising a plurality of ordered line segments, each of the plurality of line segments representing at least one action visually represented by at least one label. The method also comprises determining a line trace between a plurality of coordinates crossing at least two line segments of the plurality of line segments, each of the plurality of coordinates representing a location of user input relative to the line interface. The method also comprises determining an ordered plurality of actions based on the ordered crossings of the line trace with the plurality of line segments of the line interface. The method also comprises determining at least one user feedback event based on the determined ordered plurality of actions. The method also comprises generating at least one user feedback event on a graphical user interface based on the executed ordered plurality of actions.

In another embodiment, a non-transitory computer-readable having stored thereon computer-executable instructions to cause a processor to implement a method. The method comprises receiving coordinates at a data entry system controller representing locations of user input relative to a user interface. The user interface comprising a line interface comprising a plurality of ordered line segments, each of the plurality of line segments representing at least one action visually represented by at least one label. The method also comprises determining a line trace between a plurality of coordinates crossing at least two line segments of the plurality of line segments, each of the plurality of coordinates representing a location of user input relative to the line interface. The method also comprises determining an ordered plurality of actions based on the ordered crossings of the line trace with the plurality of line segments of the line interface. The method also comprises determining at least one user feedback event based on the determined ordered plurality of actions. The method also comprises generating at least one user feedback event on a graphical user interface based on the executed ordered plurality of actions.

In another embodiment, a data entry system is provided. The data entry system comprises a user interface configure to receive user input relative to a line interface comprising a plurality of ordered line segments, each of the plurality of line segments representing at least one action visually represented by at least one label. The data entry system also comprises a coordinate-tracking module configured to detect user input relative to the user interface, detect the locations of the user input relative to the user interface, and send coordinates representing the locations of the user input relative to the user interface to a controller. The controller is configured to allow the user to provide user input, the data entry system controller is configured to receive coordinates representing locations of user input relative to a user interface. In this regard, the user interface comprises a line interface. The line interface comprises a plurality of ordered line segments. Each of the plurality of line segments representing at least one action visually represented by at least one label. The data entry system controller is further configured to determine a line trace between a plurality of coordinates crossing at least two line segments of the plurality of line segments. Each of the plurality of coordinates representing a location of user input relative to the line interface. The data entry system controller is further configured to determine an ordered plurality of actions based on the ordered crossings of the line trace with the plurality of line segments of the line interface. The data entry system controller is further configured to determine at least one user feedback event based on the determined ordered plurality of actions. The data entry system controller is further configured to generate at least one user feedback event on a graphical user interface based on the executed ordered plurality of actions.

### BRIEF DESCRIPTION OF THE FIGURES

FIG. 1 is a block diagram of an exemplary standard keyboard, comprising an exemplary line trace;

FIG. 2A is an exemplary data entry system, comprising an exemplary data entry system controller and a touch-sensitive surface having disposed thereon an overloaded line interface;

FIG. 2B is another exemplary data entry system, comprising an exemplary data entry system controller and a touch-sensitive surface having disposed thereon a two-line overloaded line interface;

FIG. 3 is an exemplary overloaded assignment of characters to a line interface;

FIG. 4 depicts the line interface of FIG. 3 with the labels of the characters for one line segment.

FIG. 5 is an exemplary two-line line interface with an overloaded assignment of characters;

FIG. 6 illustrates an exemplary line trace on the line interface with line segments associated with the overloaded assignment of characters of FIG. 3;

FIG. 7 illustrates the exemplary line trace of FIG. 6 crossing the line interface of the line segments of FIG. 6;

FIG. 8 illustrates another exemplary line trace over the line interface of FIG. 6;

FIG. 9A illustrates another exemplary line trace with crossings, starting above the connected line segments over the line interface of FIG. 6;

FIG. 9B illustrates another exemplary line trace, with the same crossings as in FIG. 9A, starting above the connected line segments over the line interface of FIG. 6;

FIG. 10 illustrates an exemplary curve of segments and line trace crossings crossing the curve of segments;

FIG. 11 illustrates an exemplary user interface for “Scratch”;

FIG. 12 illustrates an exemplary gesture comprised of an exemplary first line trace, comprising a “continue-gesture” indication and an exemplary second line trace;

FIG. 13 illustrates two exemplary line tracings, one generated by the user's left hand and one by his right, using QWERTY ordering for the line interface;

FIG. 14 illustrates an exemplary “Scratch” line trace traversing only a single row of keys and only using directional changes;

FIG. 15 illustrates an arrangement of the keys of FIG. 14 disposed on an exemplary steering wheel;

FIG. 16A is an exemplary line interface using lower case letters in a qwerty ordering with control functionalities accessed either by pressing or by line tracing;

FIG. 16B is an exemplary line interface using upper case letters in a qwerty ordering with control functionalities accessed either by pressing or by line;

FIG. 16C is an exemplary line trace generating an upper case mode switch followed by a crossing corresponding to a question mark;

FIG. 17A is an exemplary line trace resulting a selection of one word presented by the data entry system controller;

FIG. 17B is an exemplary line trace resulting in the selection of the depicted menu option and the appearance of a corresponding dropdown menu and then residing on the numeric mode switch area;

FIG. 17C is an exemplary continuation of the line trace in Figure BJ3C exiting the numeric mode switch area and switching to the numeric mode;

FIG. 18A is an exemplary unmarked touchpad for input of a line trace and visual feedback provided on an exemplary remote display;

FIG. 18B is an exemplary chart describing the line interface controller's division between a touchpad for input acquisition of the line trace and the visual feedback on a remote display;

FIG. 18C is an exemplary touch-sensitive surface of a smart watch for input of a line trace and visual feedback provided on a exemplary display of smart glasses;

FIG. 19A is an example of a line interface with control actions for line tracing on a smart watch;

FIG. 19B is an exemplary line trace with the progress of the line trace displayed away from the line trace input;

FIG. 19C is a continuation of the exemplary line trace in Figure BJ5B with the labels reflecting a different current position of the line trace;

FIG. 20 is an exemplary line interface utilizing a motion tracking sensor for tracking of the user's fingertip and acquiring the coordinates of the corresponding line trace;

FIG. 21 is a chart with a description of the data entry system controller's handling of the data from the motion tracking sensor;

FIG. 22A is an exemplary line trace accessing the expansion control action among other control functions and suggested alternatives;

FIG. 22B is an exemplary continuation of the line trace after activation of the expansion;

FIG. 23A is an exemplary line trace of a two dimensional set of alternatives;

FIG. 23B is an exemplary line trace entering a high eccentricity rectangular box;

FIG. 23C is an example of a boundary portion appropriate to indicate a turn-around of the line trace;

FIG. 24A a) is an exemplary line trace without a clear turn-around exiting the boundary portion used for turn-around detection; FIG. 24A b) is an exemplary line trace that activates an appropriate boundary portion after entering a center circular area;

FIG. 24B is an irregular shape used for a two dimensional set of possible icons or alternatives with an exemplary line trace with a turn-around;

FIG. 25 is an exemplary square-shaped box supporting the choice of five different actions and an exemplary line trace activating Action 2 upon turn-around;

FIG. 26 is a standard 4×3 matrix arrangement of square-shaped boxes;

FIG. 27A is a two-dimensional matrix arrangement of twelve boxes each supporting up to five different actions or alternatives;

FIG. 27B is an exemplary line trace generating ordered selections among the sixty available actions or alternatives;

FIG. 28 is an exemplary line trace in a square-shaped box supporting five different actions or alternatives creating a self-intersection for selection of Action 0;

FIG. 29 is an exemplary box element with four corner boxes and one center box for the indication of a line trace direction-change;

FIG. 30 is the collection of twelve different three-point direction change indicators possible for a line trace;

FIG. 31 is an exemplary line trace generating ordered selections among available actions or alternatives after several three-point direction changes;

FIG. 32 illustrates allocations of two selection of Japanese characters to two boxes with exemplary smaller boxes at the corners and at the center for direction-change indication;

FIG. 33 is an exemplary two-dimensional rectangular-shaped organization of a 4×3 matrix offering up to five actions or alternatives for each rectangle and two exemplary line traces, generated by the left hand and right hand respectively, using self-intersection for selection among different actions;

FIG. 34A is an exemplary physical grid for generating line traces using turn-around as intent indication;

FIG. 34B is an exemplary line trace with turn-arounds generating selections among available actions and alternatives;

FIG. 35A is an exemplary physical grid for generating line traces using self-intersection as intent indication;

FIG. 35B are exemplary line traces with self-intersections for the physical grid in FIG. 35A;

FIG. 36A is an exemplary physical grid for generating line traces using three-point direction-change as intent indication;

FIG. 36B is an exemplary line trace with direction-changes generating selections among available actions and alternatives;

FIG. 37A is an exemplary physical grid for data entry using line tracing;

FIG. 37B is an exemplary physical grid with two parts, one for user's left hand and one for the right;

FIG. 38 is an illustration of the line interface for data entry based on eye tracking as well as an exemplary path of the tracked movement of the user's eyes.

FIG. 39 is a geometric depiction of an exemplary multi-level line interface using line tracing;

FIG. 40 is an exemplary illustration of the labels of the line interface presented to the user with predicted next characters in boldface;

FIG. 41 is a depiction of an exemplary, compact representation of a tree used for the prediction of next characters; and

FIG. 42 is an example of a processor-based system that employs the embodiments described herein.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed herein include data entry controllers for receiving user input line traces relative to user interfaces to determined ordered actions. Related systems and methods are also disclosed. In this regard, in one embodiment, a data entry system controller is provided. The data entry system controller may be provided in any electronic device that has data entry. To allow the user to provide user input, the data entry system controller is configured to receive coordinates representing locations of user input relative to a user interface. In this regard, the user interface comprises a line interface. The line interface comprises a plurality of ordered line segments. Each of the plurality of line segments representing at least one action visually represented by at least one label. The data entry system controller is further configured to determine a line trace between a plurality of coordinates crossing at least two line segments of the plurality of line segments. For example, the of coordinates crossing at least two line segments of the plurality of line segments may be from user input on a touch-sensitive user interface, as a non-limiting example. Each of the plurality of coordinates representing a location of user input relative to the line interface. The data entry system controller is further configured to determine an ordered plurality of actions based on the ordered crossings of the line trace with the plurality of line segments of the line interface. The data entry system controller is further configured to determine at least one user feedback event based on the determined ordered plurality of actions. The data entry system controller is further configured to generate at least one user feedback event on a graphical user interface based on the executed ordered plurality of actions.

In this manner, a user can provide data input, such as data input representative of keyboard input as a non-limiting example, by providing line traces that cross the line segments of the line interface according to the desired chosen actions by the user. The user does not have to lift or interrupt their user input from the user interface. The line traces could be provided by the user on a touch-sensitive interface, crossing the line interface for desired actions, to generate the coordinates representing locations of user input relative to a user interface, to be converted into the actions. Also, as a another example, the line traces could be line traces in mid-air that are detected by a receiver and converted into coordinates about a line interface to provide the coordinates representing locations of user input relative to a user interface, to be converted into the actions.

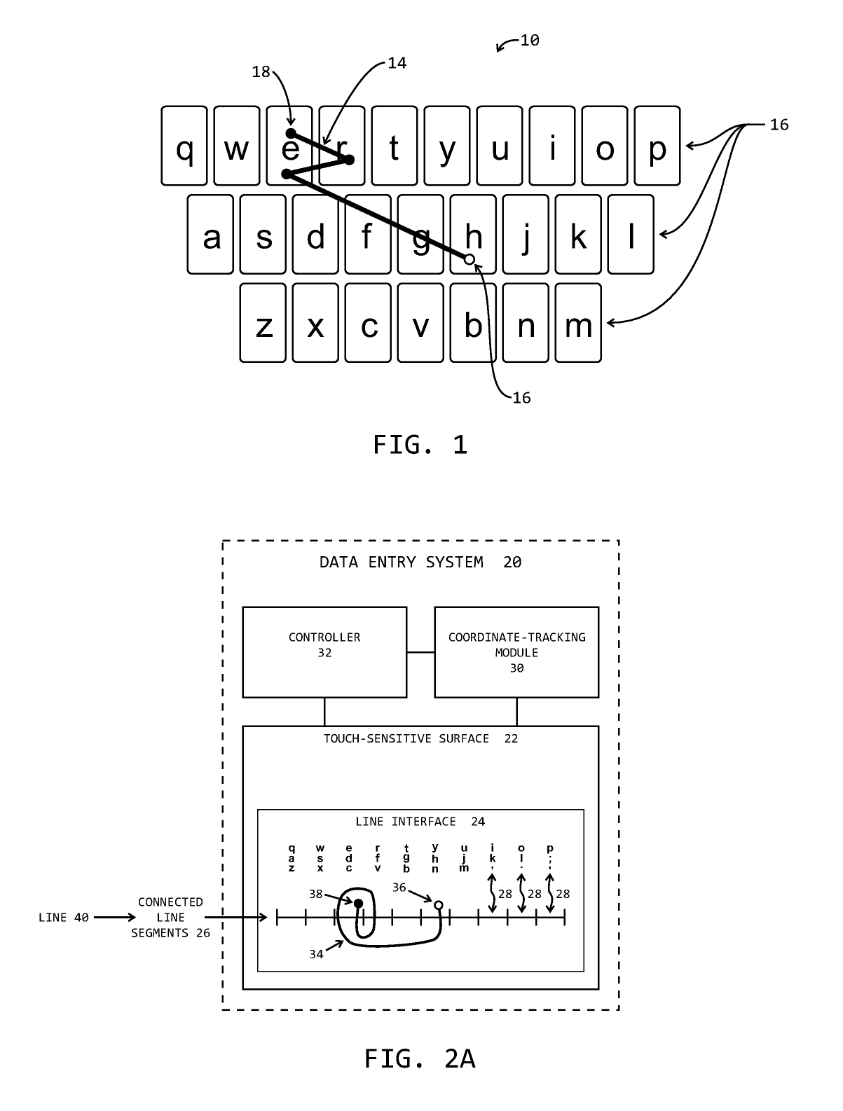

FIG. 1 illustrates a method of entering text on a virtual keyboard 10 via keys 12 by tracing a line trace 14 across the keys 16. The line trace 14 has a starting point 16 and an ending point 18. A word of text (“here”) is entered by tracing a line on the virtual keyboard 10 through keys 12 representing letters of the word to be entered, instead of tapping each key 12 individually. With such a tracing approach, a user may trace the letters of the word without losing connection with a screen (not shown), i.e., without “lifting a finger” tracing the line on the screen. A data entry system controller (not shown) may then use various algorithms for identifying the trace with candidate words. These words may not uniquely correspond to a single representative trace. For example, suppose that key registration (corresponding to a key-press event in the case of tapping on the virtual keyboard 10) occurs when the trace significantly changes direction and, in addition, also registers the start and end points 16 and 18 upon the user touching the screen. Thus, there are many different traces corresponding to any given set of key registrations. If all the different traces with the same sequence of registered keys 12 are identified, then there is a subset of these equivalence classes of traces that correspond to the words in a given dictionary. With such a dictionary, the data entry system controller ideally also provides error correction to accommodate traces that are close to words or character combinations that come close to traces arising from character combinations in the dictionary. An additional source of ambiguity arises from the fact that while generating the trace and establishing its inherent order (obtained by keeping track of the “tracing order,” i.e., the natural order with which different screen locations of the trace are touched), several words may have a same key registration. For example, the two words “pie” and “poe” may have a same trace with the tracing method indicated in FIG. 1. Due to these and possibly other sources of ambiguity, the user may be presented with a list of plausible character combinations corresponding to the trace and based on the dictionary and other auxiliary information (such as part-of-speech (POS) tags, probabilities of use, probability of typos, proximity of valid character combinations, etc.).

The tracing approach outlined above and its many variations may have several benefits. For example, since the user does not have to lift the tracing finger between key registration events, the speed at which the text is entered may be increased. Also, characters to be entered may not require key registration events at all (as mentioned above). A third factor contributing to the efficiency of the tracing method is that when the trace ends and the user disconnects the tracing finger from the screen, a state change may be registered. This state change can, for instance, be identified with a press of the space bar. This then avoids having to press a separate bar to obtain a space between character combinations, further speeding up the text entry process.

These types of tracing approaches have some inherent drawbacks aside from the ambiguities discussed above. They may require visual feedback during the tracing process to find out where the finger is located at a given moment on the underlying keyboard map. If lifting the finger off the screen is used as a registration of a certain event, such as to introduce a space character, then interruptions in the entry process due to other activities carried out by the user may be interpreted incorrectly as a state change. Further, these approaches may rely on one-finger entry (typically using the index finger) for the tracing. Hence, the speed-up possible when using more than one finger (for example, on a standard keyboard or while two-thumb typing on the virtual keyboard 10) is generally not available.

Traditional keyboards are based on pressing different keys, so each key-registration event reflects pressing a key (for example, by recognizing a key-up or key-down event). Virtual keyboards such as the virtual keyboard 10 in FIG. 1 may also use this paradigm. The keys 12 may be disposed on a surface, such as on a screen, or more generally on a two-dimensional surface in three dimensions (like a curved touchpad). The surface may also be flat. The keys 12 may also be arranged along a curve on the surface.

FIG. 2A illustrates a data entry system 20. The data entry system 20 comprises a touch-sensitive surface 22 and a crossings-based line interface 24 disposed on the touch-sensitive surface 22. The crossings-based line interface 24 is comprised of a plurality of connected line segments 26 each representing at least one character or action (e.g., “q,” “a”, “z”). The labels 28 serve as indication to the user what characters or actions are assigned to each line segment 26. The data entry system 20 also comprises a coordinate-tracking module 30. The coordinate-tracking module 30 is configured to detect contacts (not shown) on the touch-sensitive surface 22. The coordinate-tracking module 30 is also configured to detect locations of the contacts on the touch-sensitive surface 22. The coordinate-tracking module 30 is also configured to send coordinates representing the locations of the contacts on the touch-sensitive surface 22 to a controller 32. The controller 32 is configured to receive the coordinates representing the locations of the contacts on the touch-sensitive surface 22. The controller 32 is also configured to determine a line trace 34 comprised of a line between a first coordinate 36 representing a first location of the contact on the touch-sensitive surface 22 and a last coordinate 38 representing a last location of continuous contact on the touch-sensitive surface 22. The controller 32 is also configured to determine which line segments 26 of the plurality of line segments 26 that the line trace 34 crosses. The controller 32 is further configured to generate an input event for each of the plurality of line segments 26 intersecting with the line trace.

As illustrated in FIG. 2A, the line interface 28 may be a plurality of connected line segments 26 each representing at least one character or action 28. The controller 32 may further be configured to generate at least one word input candidate based on the generated crossings of the line segments. The controller 32 may further be configured to transmit the at least one word candidate for display to a user.

The line segments 26 of the line interface 24 may unambiguously represent several characters, for example, the line trace 34 crosses line segments 26 when the data entry system 20 is in a modified mode (e.g., Upper case mode, Number mode, Edit mode, Function mode, Cmd mode) or when crossed multiple times in succession (to cycle through the several characters 28). Alternatively, a line segment 26 may be overloaded to represent several characters 28 ambiguously. When overloaded keys are inputted, disambiguation performed by the controller 32 can be employed to determine which corresponding characters 28 are intended, for example, based on dictionary matching, word frequencies, beginning of words frequencies, and letter frequencies, and/or on tags and grammar rules.

The line interface 24 may be an overloaded interface comprising overloaded line segments 26. The line segments 26, each representing at least one character or action 28 of the line interface 24, may be disposed in a single row, as illustrated in FIG. 2A. Alternatively, the line segments 26, each representing at least one character or action 28 of the line interface 24 may be disposed on two or more lines, at least one line comprises a plurality of connected line segments 26.

In this regard, FIG. 2B illustrates an overloaded line interface 24′ comprising two lines 40, 42 of connected overloaded line segments 26′, each representing at least one character or action 28. The connected line segments of a first line 40 represent a first set of characters or actions 28. The line segments 26, of a second line 42 represent a second set of characters or actions 28.

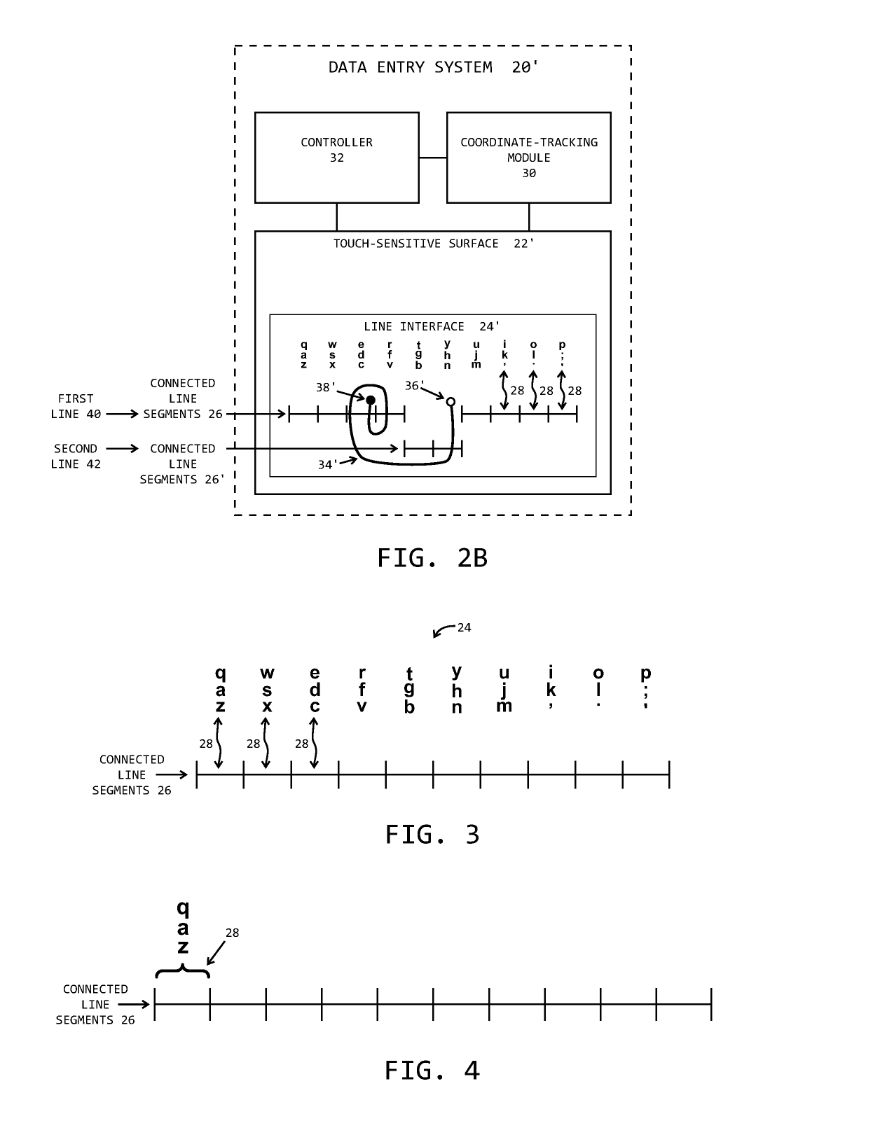

A line interface 24′ comprises a plurality of connected line segments 26, labels describing the characters or actions 28 represented by each line segment 26, and surrounding space for the user's fingers to generate line traces 34′. A registration event (not shown) is obtained when the line trace 34 crosses the line segments 26. This event then generates input associated with the characters or actions 28 represented by each line segment 26. FIG. 3 illustrates an example, comprising line segments 26, upon which a collection of characters 28 (e.g., “q,” “a,” “z”) may be associated with each line segment 26.

FIG. 4 provides another illustration of the connected line segments 26. As illustrated in FIG. 4, a line segment 26 (as a non-limiting example, a line segment 26 representing the characters 28 “qaz”) may be located along a line interface 24 with a plurality of connected line segments 26 of a set of characters or actions 28.

FIG. 5 illustrates an overloaded line interface 24′ comprising two lines 40, 42 of connected line segments 26 representing characters or actions 28. As illustrated in FIG. 5, the line segments 26 may represent two or more characters or actions 28. The characters or actions 28 of the first line 40 are comprised by connected line segments 26. The characters or actions 28 of the second line 42 are represented by connected line segments 26′.

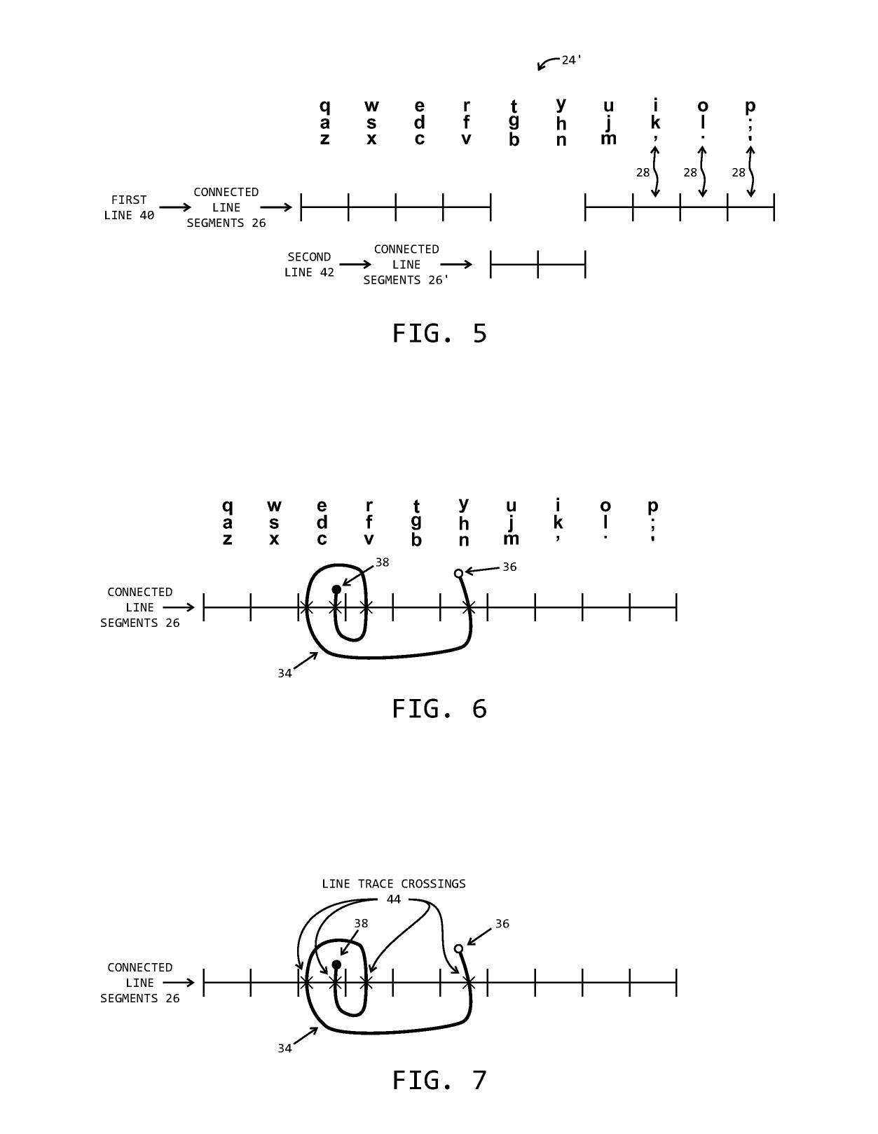

Referring now to FIG. 6, registration events for input associated with the represented characters or actions 28 can be based on crossing events (i.e., when the line trace 34, generated by the user's finger, crosses the line 40 and a particular line segment 26, representing specific characters or actions 28), instead of being based on key presses as for traditional virtual keyboards. In this example, the user starts the line trace 34 by touching the touch-sensitive surface 22. When the line trace 34 crosses the connected line segments 26, then a registration event occurs. Hence, these crossing events by the line trace 34 of the connected line segments 26 can be associated with a sequence of registration events representing the characters or actions 28. For example, a double registration event for the characters or actions 28 represented by a specific line segment 26 may be represented by a line trace 34 crossing the line segment 26 representing characters or actions 28 in the downward direction followed by the line trace 34 crossing the line segment 26 of the characters or actions 28 in the upward direction. In this fashion, the line trace 34 that the user forms with his/her finger may assume shapes (herein also called “squiggles”) for which crossings of the line trace 34 of the connected line segments 26 are identified. An event corresponding to the user's finger initially contacting the touch-i surface 22 (a “starting point” 36) may be registered as a state change and identified with a registration event for a character or action 28 (e.g., input of space character or selection of alternative word, or character combination, upon reaching an “ending point” 38). An event 28 corresponding to the user's finger disconnecting from the touch-sensitive surface 22 (an “ending point” 38) may be registered as another state change and identified with a registration event for a character or action 28 e.g., input of the space character).

A line trace 34 illustrated in FIG. 7 begins at a starting point 36 and is thereafter drawn down (selecting the “yhn” line segment 26), up (selecting the “edc” line segment 26), down (selecting the “rfv” line segment 26), and down again (selecting the “edc” line segment 26). This line trace 34 corresponds with a candidate word of “here.” However, other line traces 34 may also represent a same candidate word as long as the crossings 44 remain the same.

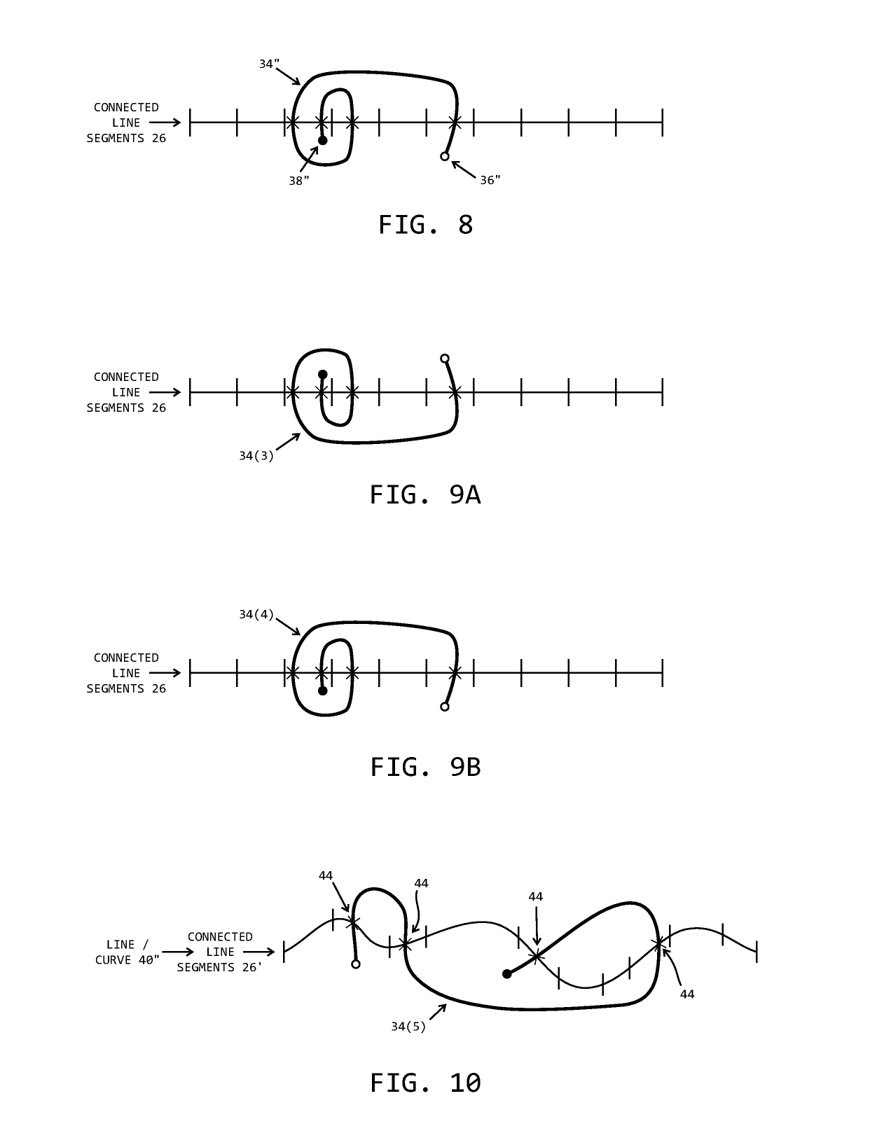

In this regard, FIG. 8 illustrates another line trace 34″ which also corresponds with a candidate word of “here.” The line trace 34″ begins at a starting point 36″ and is thereafter drawn up (selecting the “yhn” line segment 26), down (selecting the “edc” line segment 26), up (selecting the “rfv” line segment 26), and again down (selecting the “edc” line segment 26) and then ends at an ending point 38″.

FIGS. 9A and 9B illustrate other line traces 34(3) and 34(4) which also correspond to a candidate word of “here.”

The data entry system 20, and related systems and methods described herein achieve the following objectives:
Simplified key-registration events
Reduced need for visual feedback
Reduced location dependency
Fast text entry
Separation of input and output for remote operation
High precision fingertip location feedback
Midair operation of control for line interfaces
Continuous trace of main line interfaces and supporting line interfaces for control characters and actions, mode switches, and selection of alternatives
Support for one-finger, as well as multiple-finger, entry
Implementation as a physical grid with haptic feedback and little visual feedback required
Support for additional flicks and gestures
Reduced space requirements for line interfaces
Flexible designs of underlying line segment labels
Possibility to uniquely identify traces with specific registration events
Crossings-based line interface for two and higher dimensional arrays
Simple implementation
Easy to learn by relying on familiar character placements

Referring now to FIG. 10, a line 40″ of line segments 26 may be curved. For example, a line 40″ of line segments 26 representing characters or actions 28 may be a general one-dimensional curve. Though the line 40″ is curved, a line trace 34(5) may cross the connected line-segments 26′ of the characters or actions 28 of the curved line 40″ at line trace crossings 44. These line trace crossings 44 represent registration events for specific characters or actions 28 and these crossings 44 may then be translated into corresponding registration events. The one-dimensional curve used for the registration may reside on any surface, and not just on a flat shape.

Sound and vibration indicators can be added to provide the user with non-visual feedback for the different registration events. The horizontal line of connected line segments 26 may be provided with ridges on the underlying surface to enhance the tactile feedback and further reduce the need for visual interaction. A user interface for text entry may include control segments, alphabetical segments, numerical segments, and/or segments for other characters or actions 28. These can be implemented either using the different tracing methods herein described, including with regular keys, overloaded keys, flicks and/or other gestures.

With certain allocations of characters or actions 28 to different line segments 26, such as those in FIGS. 2A, 2B, 3, and 5, various disambiguation methods and predictive technologies may be used. Similarly, methods for error correction and approximations of traces may also be applied. Shape recognition for the different traces can also be used to infer the existence of the underlying crossings and registration events.

The one-dimensional methods discussed above to generate “squiggles” do not rely solely on a user tracing with his finger. Other input mechanisms is possible. The user may, for example, use a mouse, a joystick, a track ball, or a slider to generate the line trace 34.

These tracing methods for text and data entry on touch-sensitive surfaces 22 (like a touch screen or a touch pad) fall in a more general class of methods relying on “gestures.” The line trace 34 corresponding to a certain character combination is one such gesture, but there are many other possibilities. For example, with a quick movement of a finger on the screen, or a “flick”, a direction may be identified. For example, these directional indicators may be used to identify one of the four main directions (up/down and left/right or, equivalently, North/South and West/East) or one of the eight directions that include the diagonals (E, NE, N, NW, W, SW, S, SE). So, such simple gestures, so-called “directional flicks”, can thus be identified with eight different states or indications. Flicks and more general gestures can also be used for the text-entry process on touch-sensitive surfaces 22 or on devices where a location can be identified and manipulated (such as on a screen with a cursor control via a joystick).

At the beginning and end of a line trace 34, the starting and ending directions can be used to indicate more states than one. For example, these directions can be quantized into the four main directions (up/down, left/right). Hence, the beginning and end directions of the line trace 34 can be identified with the four basic directional flicks. The way the line trace 34 ends, for example, can then indicate different actions. The same observation can be used to allow the user to break up the line trace 34 into pieces. For example, if the end of a line trace 34 is not the up or down flick, and instead one of the left or right flicks, then this may serve as an indication that the line trace 34 is continued. Allowing the line trace 34 to break up into pieces means that the line trace 34 may be simplified. The pieces of the line trace 34 that are between the crossing events may be eliminated.

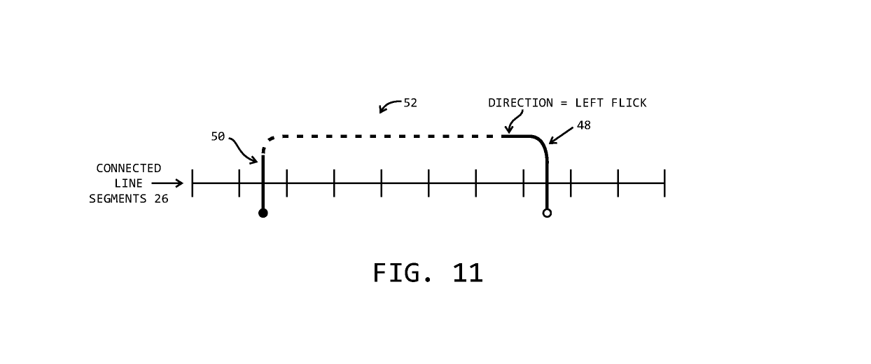

In this regard, FIG. 11 illustrates a first line trace 48 and a second line trace 50 of a gesture 52. The gesture 52 represents the word “is” using the keys of FIG. 3. The first line trace 48 selects the “i” key, and the second line trace 50 selects the “s” key. The dotted portion of the gesture 52 may be omitted because the first line trace 48 ends with a “continue-gesture” indication. A “continue-gesture” indication is an indication that the first line trace 48 and the second line trace 50 should be interpreted to be part of a same gesture 52. In FIG. 11, the “continue-gesture” indication is indicated with a left flick. Note also that the direction of the piece of the second line trace 50 corresponding to “s” can be traversed from above or from below. Using directional flicks in this manner or similar manners allows the line trace 34 to break up into smaller pieces. In particular, it also allows these smaller pieces to be generated by different fingers on possibly different hands. The pieces may even be generated on different surfaces, for instance some on the front of a device with a touch screen and some in the back.

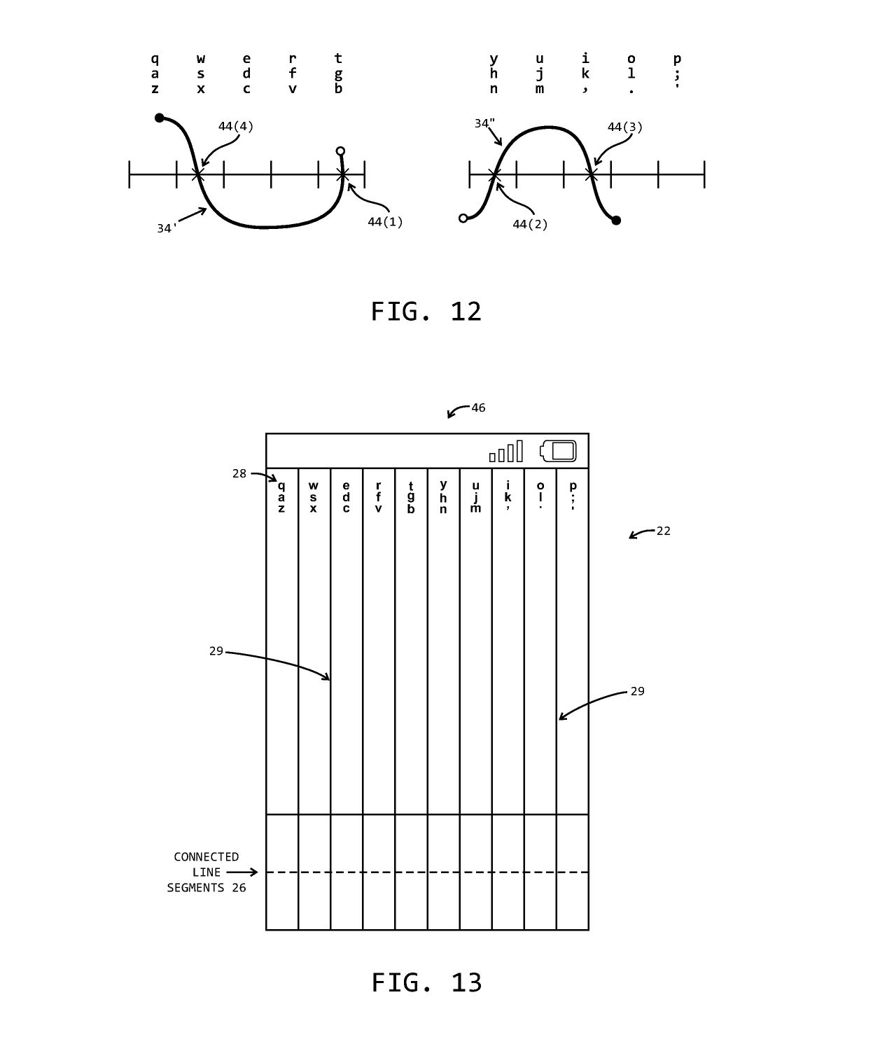

It is also possible to utilize key arrangements, such as those in in FIG. 12, to register events with a registration method based on direction changing (and including starting and ending points 36, 38). The line trace 34 of a word then generates a curve that goes back and forth along only a single row of keys 56 (herein also called a “scratch.”) In this regard, FIG. 12 illustrates a line trace 54 that only goes back and forth along a single row of keys representing characters or actions 28 (“a scratch”). Other key arrangements may alternatively be used, as long as all the keys are located along the single row of keys 56. The user's finger follows a path (a one-dimensional curve) with a defined left-to-right ordering. Hence, the one-dimensional curve, used for generating the “scratches” may reside on any touch-sensitive surface 22.

The touch-sensitive surface 22 may be provided on a mobile device, such as a mobile phone. In this regard, FIG. 13 illustrates an exemplary user interface arrangement 46 for a mobile device using “Scratch”. The user interface arrangement 46 used for generating the registration events of the line segments 26, representing the characters or action 28, is made up of vertical lines on a touch-sensitive surface 22 (e.g., touch screen), indicating the divisions between the individual key segments and corresponding characters or actions 28. The registration events correspond to the direction changes detected by the vertical lines 29 on the touch-sensitive surface 22.

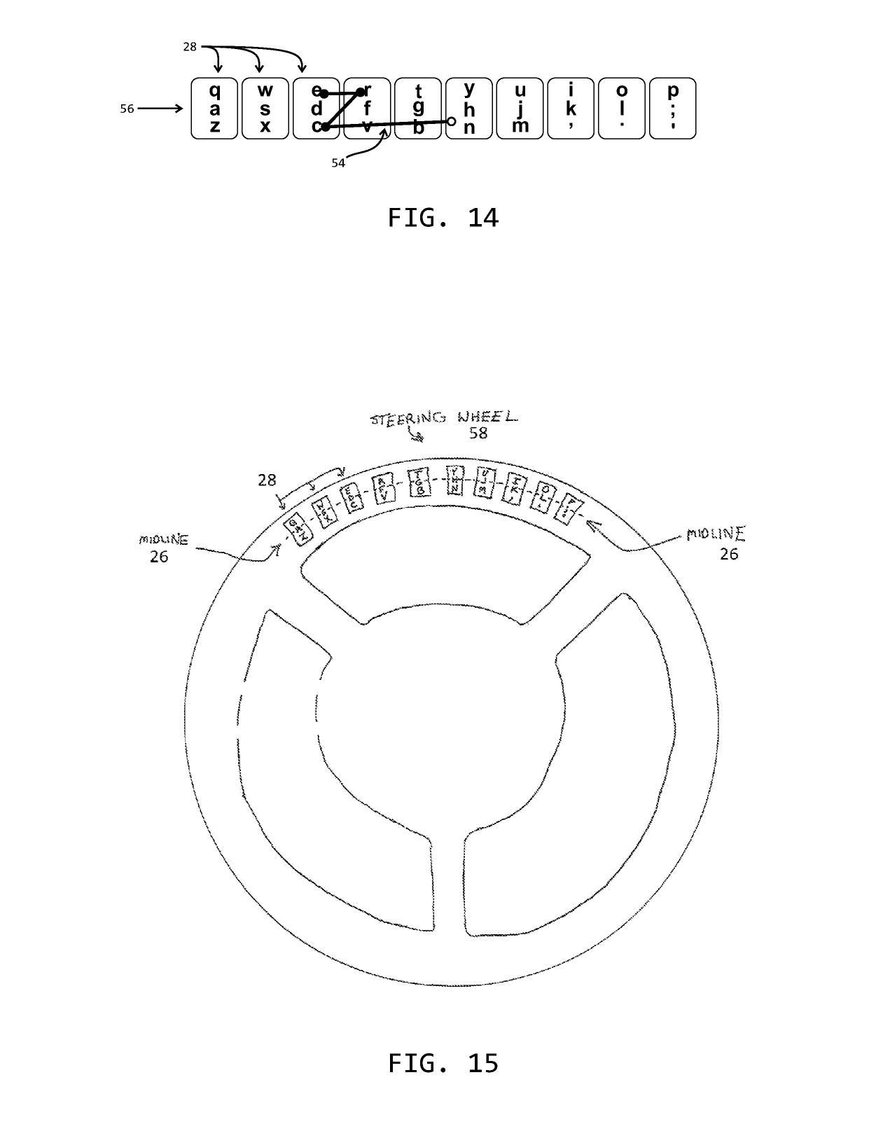

Next, please refer to FIG. 14. For touch-sensitive surfaces 22 and, more generally, when the coordinates of the line trace 34 can be obtained from several simultaneous input sources, the two-finger (or two-hand) operation of the line tracing described can be further enhanced. (Recall that a touch-sensitive surface 22 is referred to as “multi-touch” if more than one touch event can be recorded simultaneously by the underlying system; this is the case for many smartphones and tablets, for example, with touch screens). Instead of relying on flicks and gestures as just described, the important aspect is to keep track of the order between the crossing events, not whether they were generated by one finger or by the left or right thumb. In FIG. 14, the two thumbs collaborate in generating the line trace for the word “this” on a touch-sensitive surface 22. The first crossing 44(1) addresses “t” by crossing the line segment 26 for [tgb]; the second crossing 44(2) takes care of “h” by crossing the [yhn] line segment 26; the third crossing 44(3) similarly corresponds to “i”, and the fourth crossing 44(4) of the [wsx] segment is for the letter “s”. Notice that the first crossing 44(1) and the fourth crossing 44(4) are generated by the left thumb, and the third crossing 44(3) and the fourth crossing 44(4) come from the right thumb. After the user creates the first crossing 44(1) with the left thumb, the user may leave the left thumb on the touch-sensitive surface 22 while the right thumb generates the second crossing 44(2). As long as the controller 32 keeps track of the order between these crossings and no “end point” 38 is indicated (e.g., fingers leaving the surface), it is not important whether the thumbs reside on the touch-sensitive surface 22 or not. At any point, one finger may be away from the touch-sensitive surface 22. In fact, the two fingers may generate two line traces 34 (“squiggles”) and the “starting point” 36 may be determined by when either finger touches the touch-sensitive surface 22, for example, and the “end point” 38 may be determined by when both fingers leave the touch-sensitive surface 22.

This illustration and just given description make it clear that such “multi-hand” (or “multi-finger”) operation of the data-entry system 20 is possible as long as the coordinates of the crossings and the order between these crossings may be acquired. In the case of “midair operation” of the line trace 34, for example, it is possible to use both hands of a person or even have multiple people collaborate on generating a particular word or action.

In this regard, FIG. 15 illustrates a “Scratch” interface integrated into a steering wheel 58 (as a non-limiting example, a steering wheel of a car or other vehicle). As illustrated in FIG. 15, the “Scratch” interface may be disposed along the rim of the steering wheel 58.

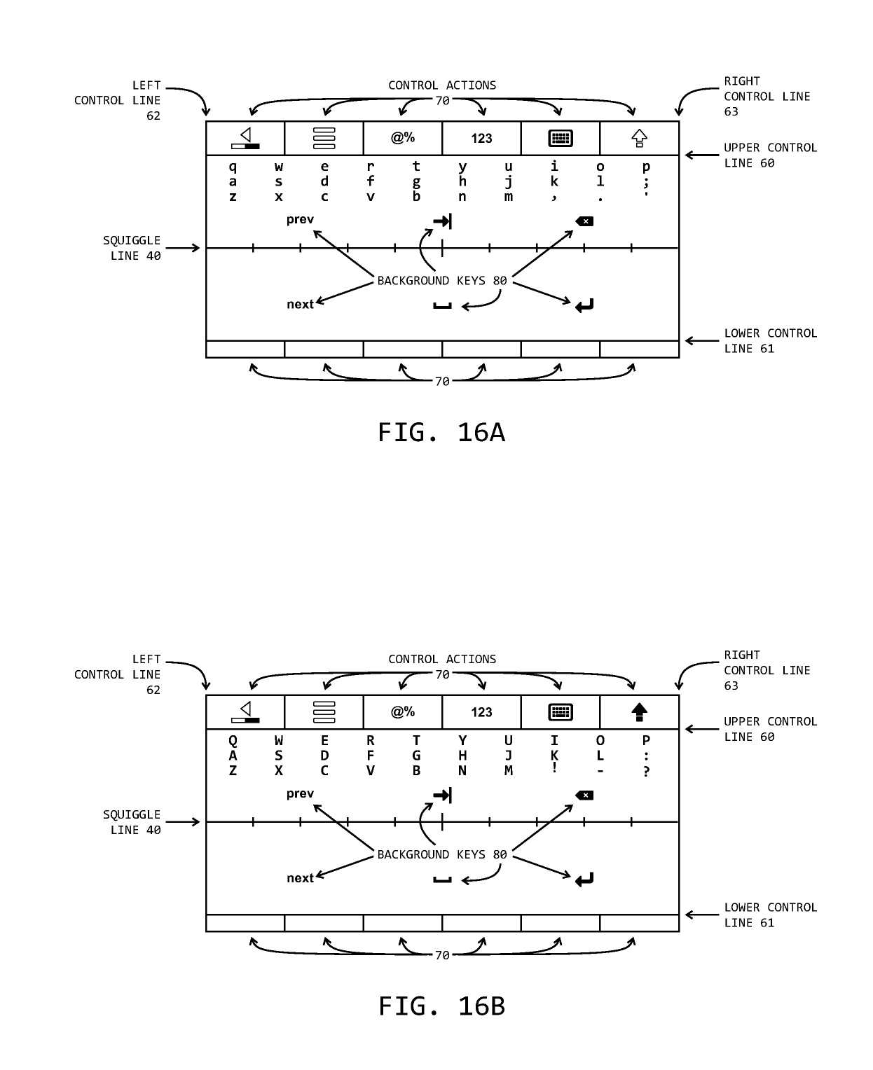

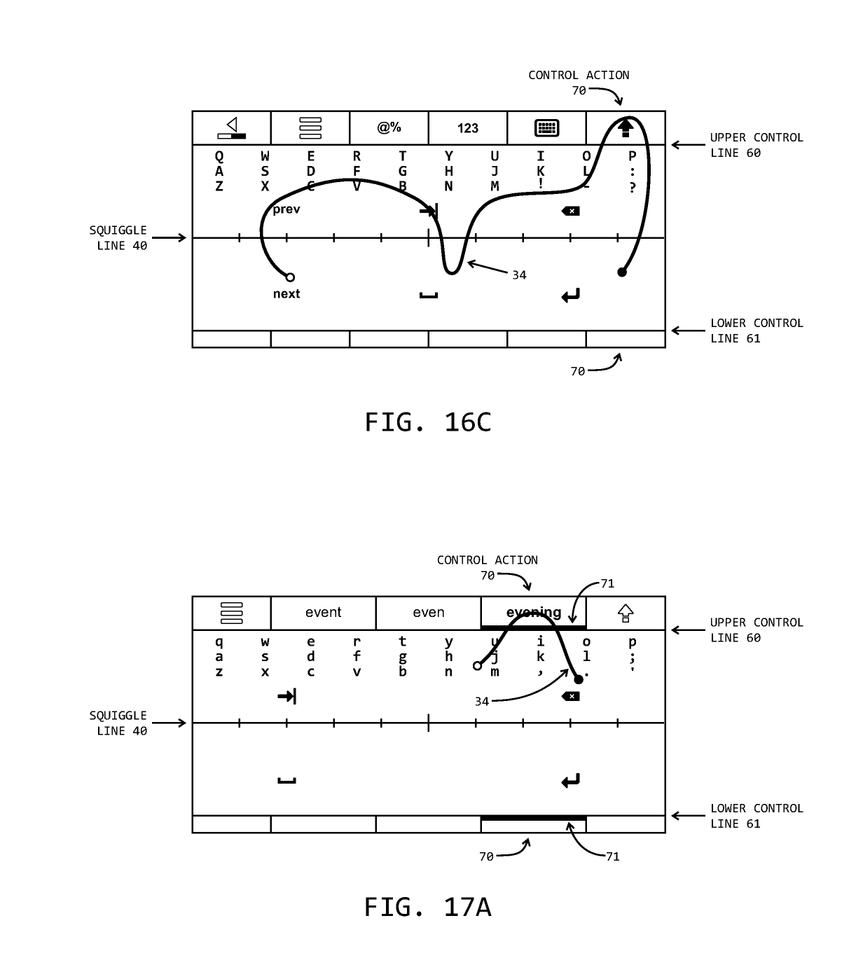

Please refer to FIGS. 16A, 16B, and 16C. There are many situations when it is desirable to add additional registration events to the basic line interface. For example, it is of interest to add some of the functionality usually assigned to so-called control keys on physical and virtual keyboards (like backspace or tab keys) to also be implemented in conjunction with the line trace for the basic entry process.

Suppose, for example, that the user enters a line trace 34 that the data-entry system displays as “invest” and obtains from the system an auto-completion suggestion of “invest|igation”. In some applications, such an auto-completion suggestion may be accepted by pressing the “tab” key. Of course, there are many other ways to accomplish this.

One options for including such control functionality is by using flicks and gestures in addition to or as part of the line trace. There are several interesting additional possibilities for the data line interface and the entry-system controller described here.

One such possibility is to simply add more segments to the basic registration line segment (or an extension of it). However, since space is often limited on portable devices, it is of interest to look at alternatives to this.

A second, related option is to add additional registration lines with additional line segments. For an example, please refer to FIG. 16A. Here there are two additional, duplicate lines 60 and 61 for control actions 70. These lines are used for six registration events associated with such control functionality: left arrow, menu, symbol mode switch, number mode switch, keyboard switch, uppercase mode switch, and so-called shift. The arrow is used to move the insertion pointer in a text field (as well as starting a new prediction when a predictive text module is used). The menu is used for invoking editing functionality (like “copy”, “paste”, “cut”, etc.). In the symbol mode, the characters associated with each of the line segments of the main line 40 are representing a plurality of symbols and, hence, by switching to this mode, the user may enter symbols. Similarly, the user may enter numbers by switching to number mode and obtain numbers 1, 2, . . . , 0 along the main line 40. The keyboard switch event allows the user to employ different types of virtual keyboards that may be preferred depending upon the particular application the user needs. The uppercase mode switch, represented by the shift icon, allows the user to access uppercase letters and certain punctuation marks associated with the uppercase distribution of characters and symbols to the line segments of the main line 40.

In addition to this control functionality associated with segments of the two additional lines 60 and 61, there are six so-called background keys 70. These are displayed in the area employed by the user to generate the line traces, and each can be pressed or tapped like keys on a regular virtual keyboard. The two keys “prey” and “next” are used to select between different alternatives, with the same crossings or with similar crossings, presented as feedback to the user by the predictive text-entry module of the controller based on the user-generated line trace and the associated crossing events. The predictive text-entry module also carries out error corrections and finds potential alternative character combinations associated with similar sequences of crossing events. The tab key is used to accept auto-completions suggested by the predictive text-entry module as well as tabbing in a text field or moving across fields in a form and in other documents and webpages. The backspace removes characters from the right in the traditional manner. The space key and the return/line feed keys also function in the traditional manner.

In different modes, the line segments on the main line 40 may thus represent different characters and actions than the lowercase text mode with letters and the punctuation marks; see FIG. 16A. In the uppercase mode for example, illustrated in FIG. 16B, the uppercase letters are made available along with certain other common punctuation marks. In FIG. 16C, the user inputs a line trace 34 corresponding to the displayed characters “why” after processing by the predictive text-entry module. He then continues the trace 34 across the upper control line 60. Upon coming back across the control line 60, the uppercase mode switch is executed. The line trace 34 next crosses the main line 40 in a segment corresponding to, among several characters, the question mark “?”. The predictive text-entry module then displays the suggested interpretation “why?” to the user and also provides other choices (in this example accessed by using the background keys).

As in the example in FIG. 16C, if the user wants to access any of the registration for specific control functionality associated with the upper and lower control lines 60 and 61, then he allows the line trace 34 to cross the appropriate segments of the lines 60 and 61. The two lines 60 and 61 are associated with exactly the same functionalities and are essentially copies or mirror images of each other. Since they offer the same functionalities, they may visually be presented to the user in a space-saving manner; in FIGS. 16A, 16B, and 16C, the icons of the segments for the lower control line 61 are not provided since they are identical to those for the upper control line 60. The reason for having two copies 60 and 61, representing the same characters or actions, is to make it possible for the sequence of crossing events (in addition to any starting stage) to represent the same user feedback event; this allows the user to still cross and re-cross the main line 40. In particular, the line trace 34 may exit on either side of the main registration line 40 since the associated crossing events remain the same.

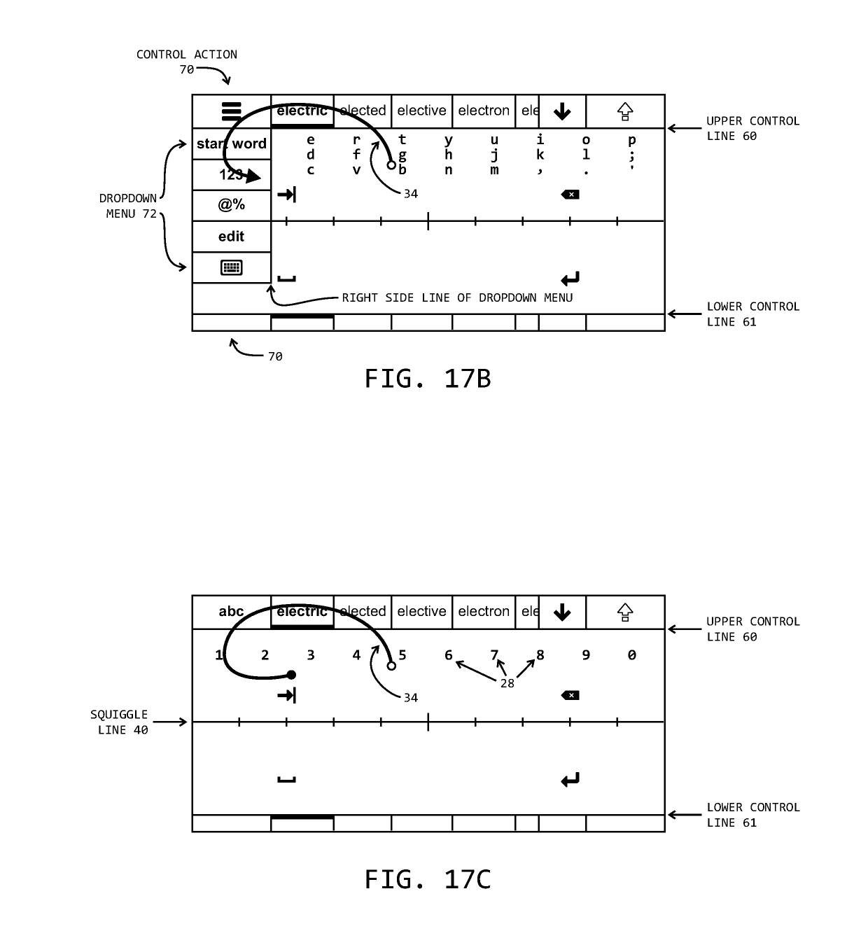

Next, please refer to FIGS. 17A, 17B, and 17C. In these figures, the area above the upper control line 60 and the area below the lower control line 61 are used for two control functionalities 70 as well as for the display of several alternatives generated by the predictive text-entry module for the user to choose from. Upon presentation of such alternatives, as illustrated in FIG. 17A, the user's line trace 34 continues across the upper control line. The entry system controller registers the position of the line trace and presents a line segment for the user to cross; in FIG. 17A this is represented by a thicker line segment. Upon crossing this segment from above, the particular word associated with the segment is selected. In this example, the word “evening” is selected.

Similarly, in FIG. 17B and FIG. 17C, the user's line trace first crosses the upper control line, then continues to the menu line segment on the left. Upon exiting across this segment, a menu is displayed by the system. The user may then continue the line trace into this menu. In this example, he continues to the number mode option and then exits across another registration line 62. This causes another crossing event and the system then switches to number mode, and the line segments on the main line 40 are now representing the numbers 1, 2, . . . , 9, 0. The user may now continue the line trace as in Figure BJ3C and enter numbers.

Referring now to FIGS. 16A, 16B, 16C, 17A, 17B, and 17C, the two additional control lines 60 and 61 provide the same functionality as mentioned. To further explain this, please note that for the main line 40 there is no distinction whether the user's line trace 34 ends up above or below the line 40. These two situations are considered the same, and this is what makes it possible to stay within a limited area (in this case, in the y-direction). When the user's line trace 34 crosses either of the control lines 60 or 61, this is not the case without extra consideration. Specifically, the two sides of each of the control lines are initially different: on one side of the control line 60, for example, the access to the main line 40 is direct; on the other side of the control line 60, the user's line trace 34 has to cross the control line 60 again. To address this difference between the two sides of each of the control lines, it would be possible to introduce repeated copies of the main line 40, and repeated copies of the particular control line. So, this would force a large screen or a progression of screens (here in the y-direction) for displaying the visual feedback to the user. A way to avoid this is for the new characters or actions associated with each of the control lines 60 and 61 not to be identified with each crossing of these control lines. Instead, it is required for these control lines that the line trace 34 crosses the particular control line in both directions (up and down for the upper control line 60, or down and up for the lower control line 61) so that the user's line trace returns into the area again with direct access to the main line 40. To be able for the two sides of the main line 40 to have the same access to control functionalities, the control lines 60 and 61 must thus offer the same functionality.

So the character or action associated with a line segment on these control lines 60 and 61 is registered only after both crossings. Hence, each crossing of a specific control line corresponds to only half of the required activity for the user to register a control action. Each crossing is thus analogous to “½ a key press” on a virtual keyboard (like “key-down” and “key-up”). This, in turn, means that there is flexibility in deciding what each crossing is defined as since the crossings in both directions are associated with the characters and actions. This can be utilized both for the first, “entry” crossing and the second, “return”/“exit” crossing to precisely determine what the corresponding action is. In this embodiment, discussed in these figures, the control action is associated with the “exit” and upon crossing one of the control lines 60 and 61 into the area where direct access to the main line 40 is obtained. The “entry” crossing (i.e., in the upward direction for line 60 and the downward direction for line 61) is used by the system in this embodiment to “pause” the line trace. In this “pause” state, the background keys can be pressed or tapped. Similarly, the different control functionalities associated with the control lines 60 and 61 can be registered by tapping the appropriate area above line 60 or below line 61; this allows the user to employ either the crossing events of the line trace or the tapping of the appropriate area to cause one of these control functionalities to be executed by the system. Additionally, the line trace may be continued between the control lines 60 and 61.

The data-entry system based on the line interface and crossings described has many important features. One feature is that the user's input may be given in one place and the system's visual feedback may be presented in a separate location. This means that the user does not have to monitor his fingers; it is enough for the user to rely on the visual feedback to follow the evolution of the line trace and how this trace relates to the main line with its line segments. This is analogous to the operation of a computer mouse when the hand movements are not monitored; only the cursor movements on a computer monitor, not co-located with the mouse, have to be followed. It also means that the data-entry system may rely on user input in one place and provide the user visual feedback in another; hence, the line trace may be operated and controlled “remotely” using the potentially remote feedback.

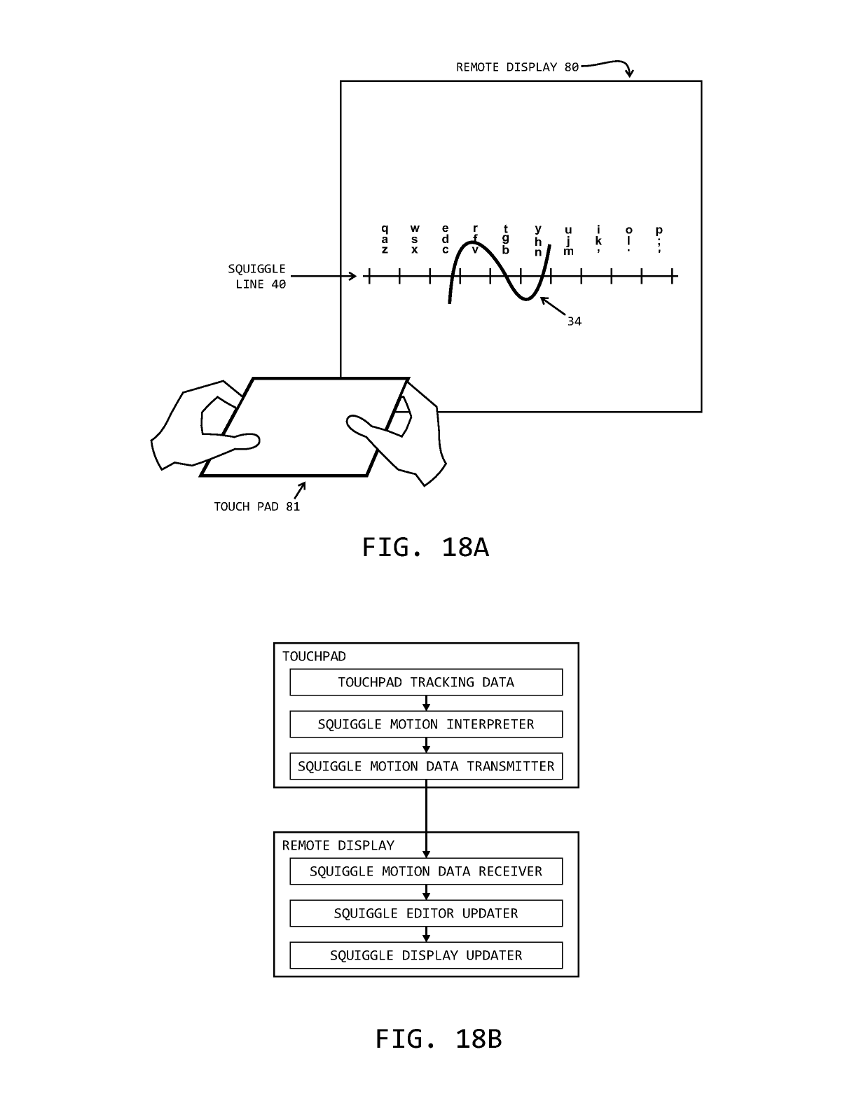

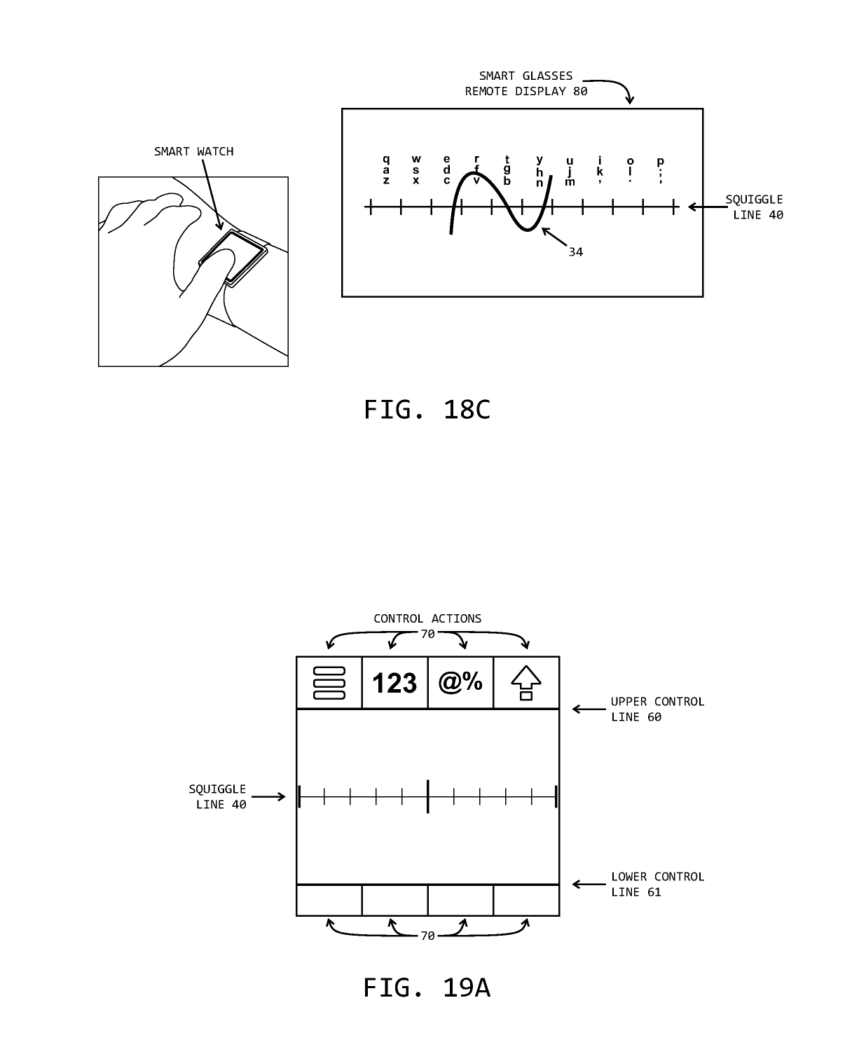

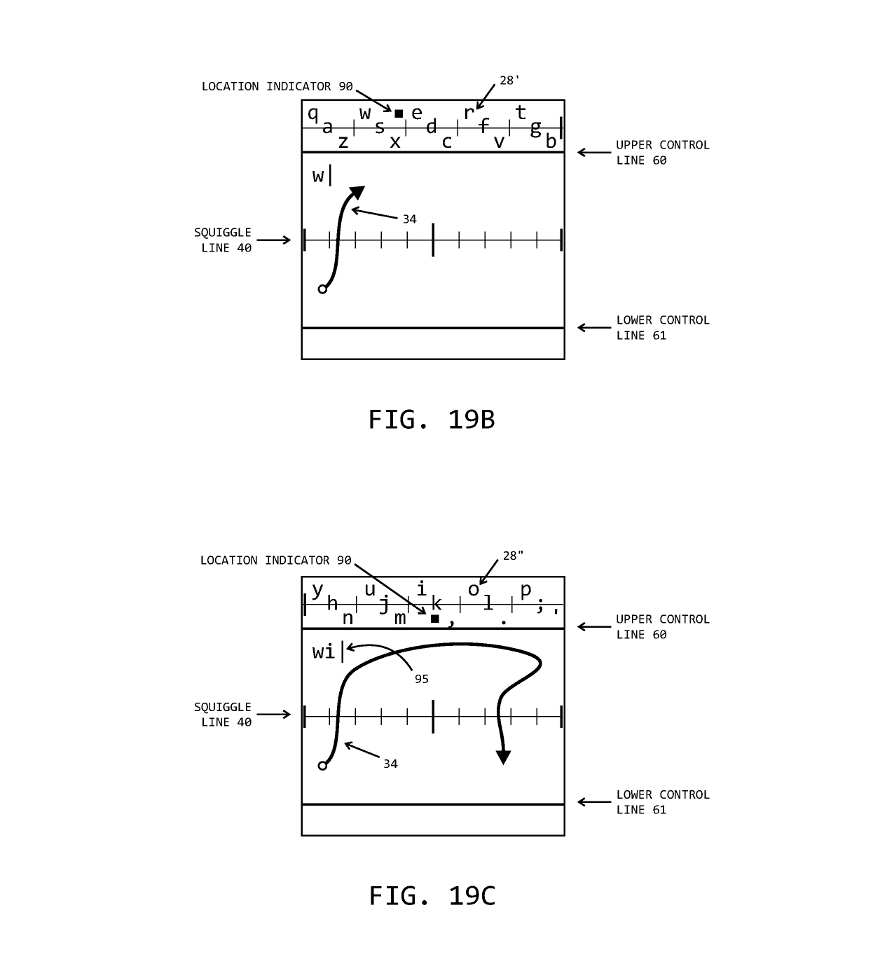

To discuss this further, please refer to FIGS. 18A, 18B, 18C, 19A, 19B, and 19C.

In FIG. 18A, the user provides his input and generates coordinates on a touchpad 80 with a virtual line interface not necessarily marked on the touchpad. These coordinates are transmitted to the controller either through a direct connection or through a wireless connection (such as a WiFi or Bluetooth connection). The system then displays the progression of the line trace 34 on a remote display representing the line trace of the user input relative to a displayed user interface with main line 40. One of ordinary skill in the art will recognize that the touchpad 80 may be replaced by many other devices (smartphone, game console, tablet, watch, etc.) with the capability of acquiring the locations of the user's fingertip (or fingertips) as time progresses.

The system is further detailed in FIG. 18B.

As one of ordinary skill in the art will further recognize, the remote display may be a TV, a computer monitor, a smartphone, a tablet, a smartwatch, smart glasses, etc. In FIG. 18C, this flexibility is illustrated by allowing the remote display to be rendered on smart glasses worn by the person operating the touchpad or other input device.

The “remote display” can also occur on the same device and still offer important advantages. For this, please refer to FIGS. 19A, 19B, and 19C. In these figures, an implementation of the data-entry system controller described on a small device, like a smartwatch, is illustrated.

In FIG. 19A, the basic interface is shown with appropriate control actions 70, associated with the top control line 60, with graphical representations at the top and corresponding segments for the lower control line 61 indicated at the bottom. The user enters the line trace, and this trace crosses the main line 40.

As illustrated in FIG. 19B, when the line trace is being created, the description of the progress is presented to the user at the top of the screen. This presentation includes a portion of the labels 26 relevant to the particular location of the line trace (and the user's fingertip). The presentation also includes a location indicator dot 90 that allows the user to precisely understand where the system is currently considering the line trace 34 to be in relationship to the main line 40 and its line segments. FIG. 19C illustrates that as the user's fingertip moves to a different location to enter the intended letters, the system changes the presentation to the appropriate letters and actions associated with the line segments in the vicinity of the current location of the line trace. Hence, the presentation of the progress of the line trace and its crossings is kept essentially separate (or “remote”) from the area where the line trace 34 is being generated. Notice that in FIGS. 19A, 19B, 19C the line trace 34 is being entered in an area that is also being used to provide visual feedback about the text and characters being entered.

This ability to exactly represent the location of the line trace to the user allows the user's fingertip to act like a precision stylus. The fingertip no longer hides the display of the progress of the line trace from the user. And the user does not need to rely on or understand the location of his fingertip; the user only needs to follow the location indictor dot since this is what the system utilizes.

This makes it possible for the user to employ his fingertip in a precise manner and avoid the restriction of a key area on a virtual keyboard; here the line segments may be substantially smaller since the user may cross the main line 40 with great precision.

Another interesting possibility is for the display of the progress to be placed at the insertion point of the text being entered. More precisely, enough feedback about the ongoing entry process can be provided at the insertion point; the entire feedback may be presented to the user as a modified cursor. Notice in this respect that only sufficient feedback to the user needs to be presented to allow the user to understand the current location of the line trace with respect to the line segments of the main line 40. This can be accomplished with a location indicator dot and single characters or graphical representations of the labels 26 as long as the user is familiar with the representation and assignments of characters and actions to the different line segments. This representation is very compact, and it allows the user to follow the progress of the entry process in one place, namely where the text and characters are being entered.

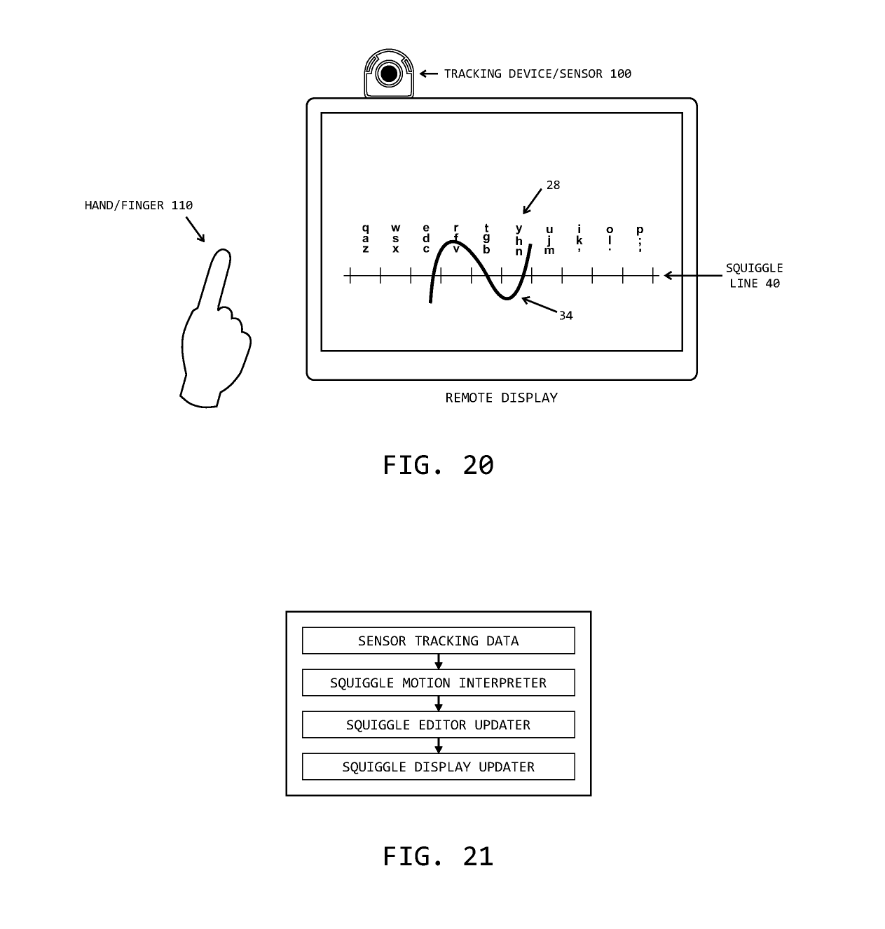

Another important feature of the data-entry system based on the line interface and crossings is the fact that it can be operated in “midair”. For this, please refer to FIGS. 20 and 21.

Instead of obtaining the line trace coordinates from the user's fingertip on a touch-sensitive surface, it is possible to add a motion-tracking sensor and obtain these coordinates from specific locations in three-dimensional space as illustrated in FIG. 20. In this illustration, the motion-tracking device 100 is assumed to track the user's fingertip and present the locations relative to a plane parallel to the remote display. These coordinates are determined by the motion-tracker module now added to the controller as in FIG. 21. Based on the line trace 34 in the plane parallel to the remote display unit, the user input via his fingertip movements are once again presented as visual feedback to the user. The user may now control the line trace 34 and its crossings with the main line 40 and, hence, enter data. While for a touch-sensitive surface the “starting point” of contact and the “end point” of contact may be defined by touching the touch-sensitive surface, for this midair operation another set of indicators must be used. Here there are many possibilities. For example, the entry system may provide a bounding box. As soon as the system identifies coordinates of the line trace, corresponding to the fingertip locations, inside this box the line trace has been started, and a starting point is derived, and then the trace is ongoing; when the coordinates of the line trace exits the box, the “end point” of the line trace has been reached. Alternatively, instead of bounding box, certain hand gestures may be used. For instance, if the hand is closed, without a distinguished, separate finger and corresponding fingertip, then the line trace tracking and collection of coordinates may be stopped; the tracking starts when the motion-tracking module interprets the user's hand movements and identifies a fingertip. As one of ordinary skill in the art will recognize there are numerous other possibilities for starting and stopping the line trace based on gestures, number of fingers, direction of pointing finger, etc.

Similarly, there is a wide array of sensors that can be used for the motion tracking. Since the line trace is with respect to a planeclose to being parallel to the remote display unit, this particular embodiment is inherently two-dimensional, these sensors may rely on two-dimensional, planar tracking and include an IR sensor (tracking an IR source instead of the fingertip, for instance), a regular webcamera (with a motion interpreter). It is also possible to use more sophisticated sensors like 3D optical sensors for finger and body tracking, magnetometer-based three-dimensional systems (requiring a permanent magnet to be tracked in three-dimensional space), ultrasound and RF-based three-dimensional sensors, and eye-tracking sensors. Some of these more sophisticated sensors offer very quick and sophisticated finger- and hand-tracking in three-dimensional space. This often simplifies or improves extraction of the designated portion of the human body that generates the necessary coordinates for the line trace. This is particularly important in environments where the background may be changing or where there are multiple people present and being observed by the motion-tracking sensor (and only one or certain designated people are intended to generate line traces). Typically, these more sophisticated sensors also provide the planar description of coordinates used by the line tracing and the data entry system controller.

The basic data-entry approach described so far involves the reduction to crossings of a line (and in particular a specific line segment) at appropriate points. The triggering event is thus a crossing.

When the different actions can naturally be organized along a curve, then this basic system is applicable. However, there are many situations when such an organization is not particularly suitable. In many cases, it is more natural to organize the data in a two-dimensional, or higher-dimensional, array.

The ideas behind the data system controller described so far can be modified to handle such situations as well. It is again a matter of reducing dimensionality, and utilizing crossings of curves and line segments to trigger events. Next, several such possibilities will be described.

The basic idea is to dynamically define a line segment or boundaries to cross for each element in a two-dimensional array or organized in a two-dimensional fashion (as one of ordinary skill in the art will recognize, the same approach will work with higher-dimensional arrays and organizations as well).

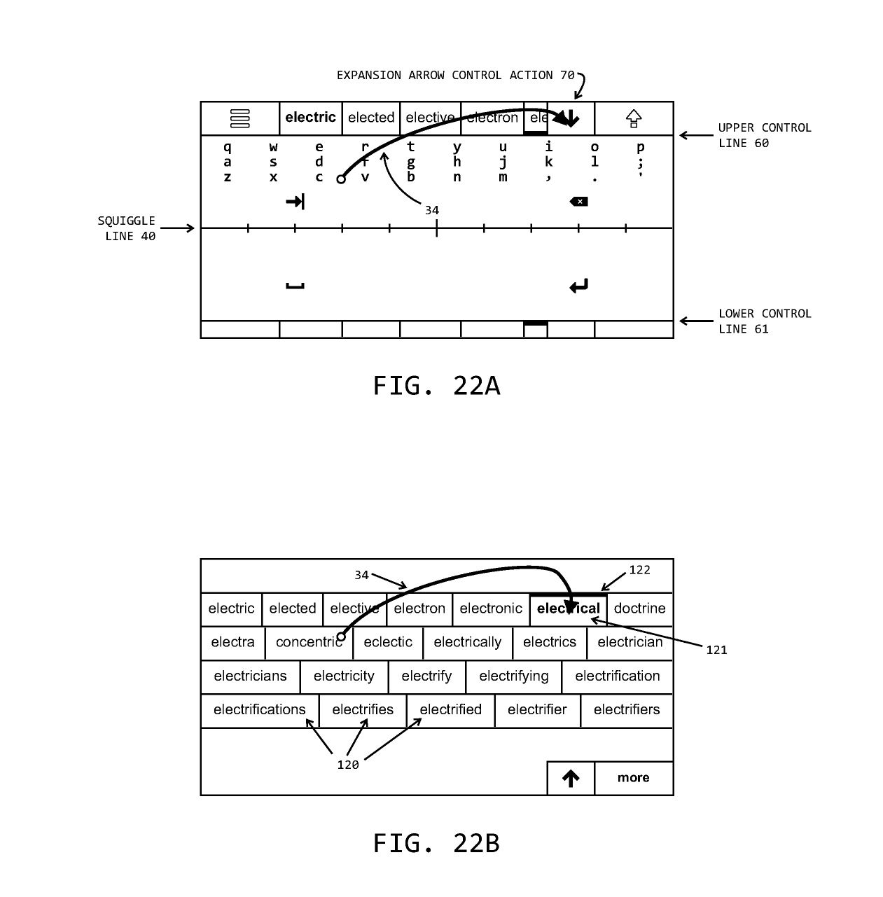

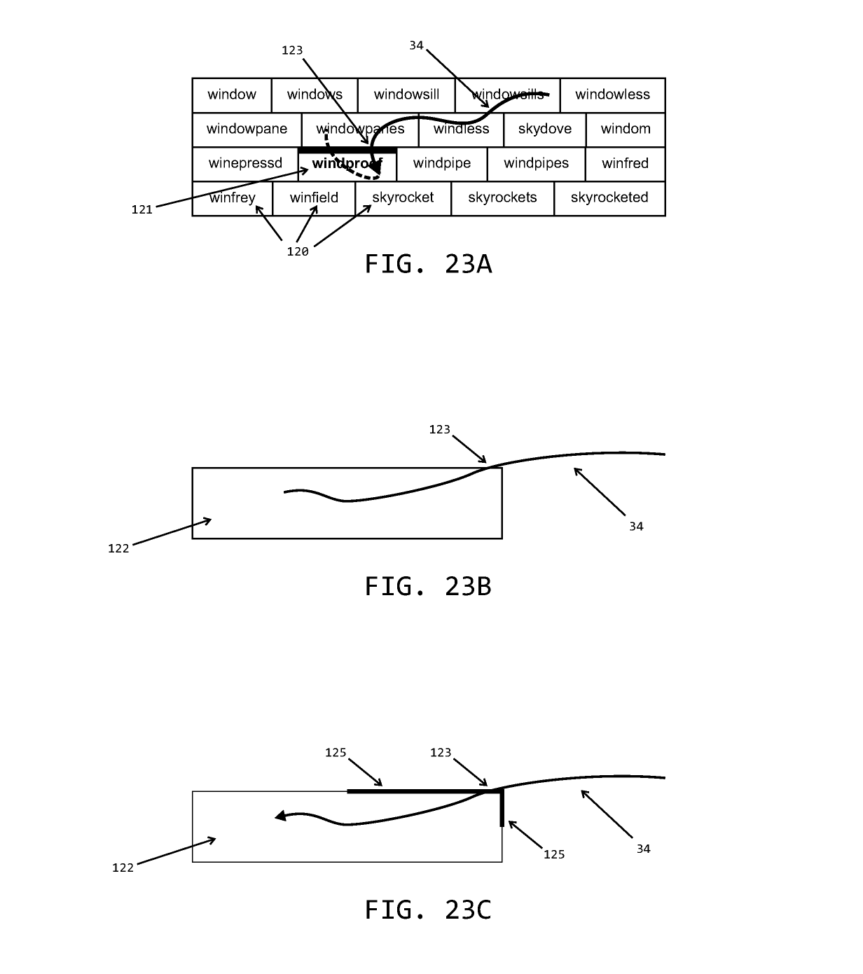

For this, please refer to FIGS. 22A, 22B, 23A, 23B, and 23C. To motivate one possible selection of such a dynamic line segment, consider the motion of the user's fingertip. As the user slides his/her fingertip across the two-dimensional data set as in FIG. 22A, there is a natural trajectory of the fingertip as the user continues moving the fingertip. The expected trajectory is to simply continue the motion in the current direction; hence, as long as this motion continues approximately in the given direction, then we expect the user to still be travelling towards the intended element in the set. Of course, the user may continuously change this direction. The intent is now to single out a motion (“gesture”) that shows intent on behalf of the user. The most significant change in the trajectory is likely if the user's fingertip turns around and significantly changes direction of about 180°. Other significant changes of the trajectory may also signal the user's intent. For example, it may be assumed that an abrupt direction change (and not just turning around), a velocity change, etc., corresponds to instances when the user intends to select an item.

If the “turn-around” is used as the indicator of the user's intent to select an item, then there are several implementations to incorporate such “turn-arounds” for selection during the line trace generation. To be consistent with the overall line trace and entry process, a line segment will be offered and displayed for the user to cross. If the assumption is made that each element of the data set is identified by a rectangular box with axes parallel to the x- and y-axes, as in FIGS. 22A, 22B, and 23A, then the side through which the fingertip entered the rectangular box 120 may be associated with the side that requires the user to “turn around” in box 121 in order to cross the same side again.

So, to select an element the user “turns around” and crosses the line segment associated with such a turn-around. As long as the fingertip continues through one of the other three sides, then no selection is made.

If the fingertip enters through the left side, then this side is used as an indication that the line trace is going from left to right. And this left side becomes the line segment for the user to cross to register a “turn-around” and trigger a selection. If the trajectory is going diagonally or in some direction that is not so easy to discern, then the entry side may still be used as the line segment for a “turn-around” and for triggering the selection. So, the sides of the rectangle around the element are used as a coarse and rudimentary way to indicate the direction of the trajectory and, in particular, to generate the “turn-around” and selection. Instead of simply using the entry side, other descriptions of the line trace trajectory may be used. For example, if the trajectory is going diagonally from the left top towards the right bottom of the screen, then it may be better to use both the left and the top side of the rectangular box.

The choice made here to indicate intent, the “turn-around” of the trajectory, has a fascinating connection with the research into visual processing and information processing. The role of curvature in visual processing has received a lot of attention since the famous suggestions by Attneave (1954) that the information along a visual contour is concentrated in regions of largest magnitude of the curvature along the contour. See J. Feldman and M. Singh, “Information along contours and object boundaries”, Psychological Review 2005, vol. 112, no. 1, pp. 243-252, for recent references and a description of this connection.

The use of the entry side to indicate a “turn-around” is not always a particularly good choice. For example, suppose the rectangular box 122 has high eccentricity; see FIG. 23B. In the case of the line trace 34 with entry point 123 indicated in this figure, the right side is a better description of “turning around” than the top side since the top side may only require a minor direction change (and nothing close to) 180°.

A better choice of the turn-around indicator may be as shown in FIG. 23C. If the line trace 34 exits this rectangular box 122 along the bold-faced portion 125 of the boundary, then that is a better approximation of “turn-around”.

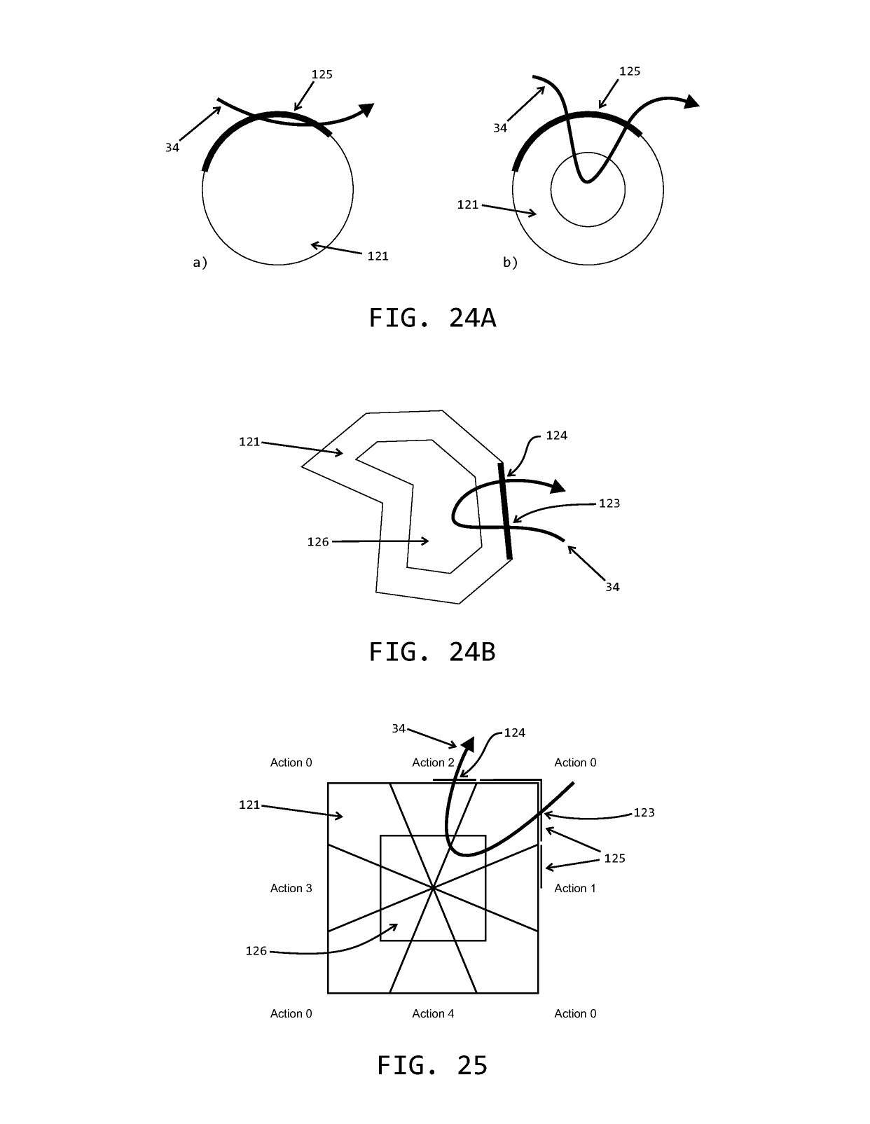

Next please refer to FIG. 24A and FIG. 24B. The just-described problem is not limited to high-eccentricity rectangles. Take a circular-shaped area as in FIG. 24A and assume that the line trace 34 just glances this area; see FIG. 24A a). In this figure, after entering the circular area, there is a designated arc through which the squiggle may leave the circular area and be considered a “turn-around” indication. However, as the example shows, this designated arc does not always capture the notion of “turn-around” well. Instead we may proceed as in Figure FIG. 24A b). In this example, the “turn-around” is not invoked until the squiggle passes into the inner circular area. And then, to trigger the “turn-around” indicator, the squiggle has to leave through the designated arc.

Notice that this approach can also be used in other settings. For example, suppose a screen (the “home screen”) is occupied with icons. To enable the line trace to indicate a selection of such an icon, without requiring the user to tap an icon to activate it, then the above approach may be used. The icon may be assigned a rectangular bounding box (with the axes parallel to the screen boundary), and then the “turn-around”-based triggering may be used. If a more irregular shape is preferred to describe the boundary of the icon, then an inner “core” and a designated “turn-around” portion of the outer boundary may serve the same purpose. Please refer to FIG. 24B.

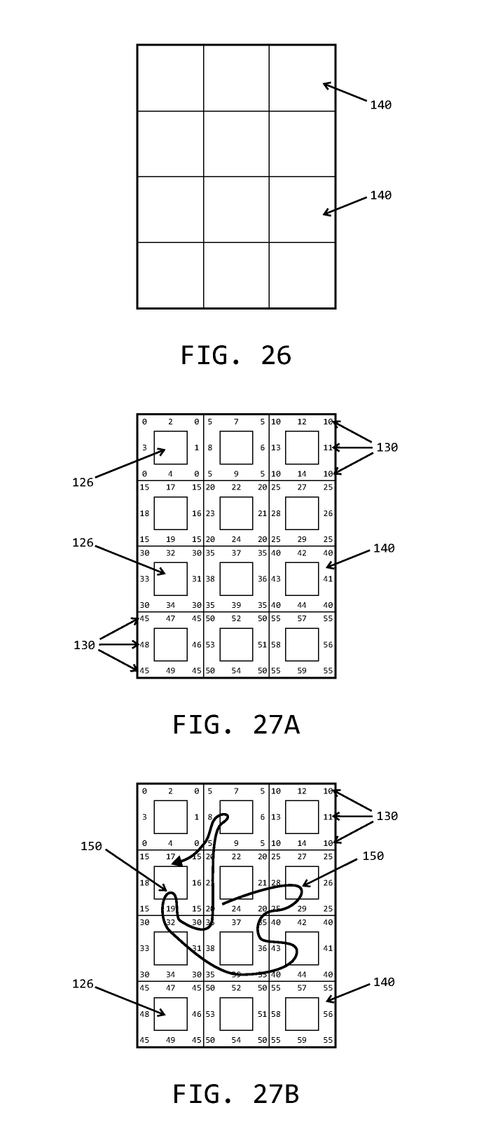

It may also be necessary to choose more than one action (so far, this action has been described as “selection”) associated with the area for each item in the two-dimensional array or more general organization of two-dimensional data. Next, consider the case when we want to associate such an area with several actions. To be specific, the assumption is made that the area is square-shaped (general shapes can be handled similarly). Further, assume that there are five actions to be associated with this square (up to eight may be handled without any significant changes). The purpose now is to still use the “turn-around” indicator as used for the single action. In particular, portions of the boundary will be used to indicate a “turn-around”. Please then refer to FIG. 25. Here, there is a basic division of the boundary into eight portions corresponding to eight sectors; some of these boundary portions are identified with the same action. (Of course, the choices of the boundary portions may be changed as well as the associations with the different actions.)

The “turn-around” approach for selection can be used in this situation as well. If the user wants to execute Action 0, say, then he may enter the box at an entry point 123 through one of the four boundary portions associated with Action 0, and then leave through the same portion. To avoid accidental triggering of an action, it is possible to add the notion of a core of the square as discussed above. There is another feature that makes it easier for the user to carry out the intended action. To reduce the precision required when the user enters and exits the boundary at the exit point 124, a “tolerance” to the portion of the boundary used for the exit may be provided. For example, say the user enters through an Action 0 portion of the boundary; see FIG. 25. Then, the user may exit the boundary through the same portion of the boundary and trigger Action 0. However, the user is now also provided the opportunity to exit through an Action 1 or through an Action 2 portion of the boundary. In other words, the dynamic squiggle curve that becomes available for triggering now offers three different boundary portions and corresponding actions. As indicated in FIG. 25, the “neighboring” actions may require more precision to be triggered; this is simply a design decision (just like the size and precise shape of the core). In this figure, the line trace exits at the exit point 124 through an Action 2 portion of the boundary, and that is then the action that is carried out although the box was entered at the entry point 123.

Please now refer to FIG. 26, FIG. 27A, and FIG. 27B. To illustrate some of the possibilities described so far, the context of the 4×3 layout, associated with a traditional numeric keypad of a cellphone as in FIG. 26, will be used.

The assumption is that each of the twelve areas is associated with, say, up to five different actions. This is an important example since this is the case in the standard implementation of Japanese keyboards on the 4×3 matrix. As an example, allocation of these five different actions using tapping and so-called flicks (a flick is a short movement of the finger, often with an originating location), the tapping of a particular area once is assumed to be associated with one action, Action 0. By first pressing the particular area and then leaving the area through the right side, the next action, Action 1, is obtained. If instead the area is exited, after tapping, through the top side, then Action 2 is obtained; leaving through the left side yields Action 3; and leaving through the bottom produces Action 4.

The corners of each square are used to indicate one action for each of the twelve squares (Action 0, Action 5, etc). In FIG. 27A there are thus up to 60 actions 130 possible.

Now, to select the different actions, the user moves the line trace 34 to the different areas and uses the “turn-around” approach to invoke the different alternatives. Cores 126 may also be added to these areas to avoid accidental triggering, and multiple actions upon exit (the so-called “turn-around with tolerance”) may be allowed; please see FIG. 25. In FIG. 27B a possible line trace 34 is illustrated for choosing Actions (or alternatives) 25, 40, 19, and 5. For example, to invoke Action 40, the user happens to enter through a boundary portion associated with Action 43, and, using the tolerance, he may then exit through the boundary portion associated Action 40 for the selection of that particular action.

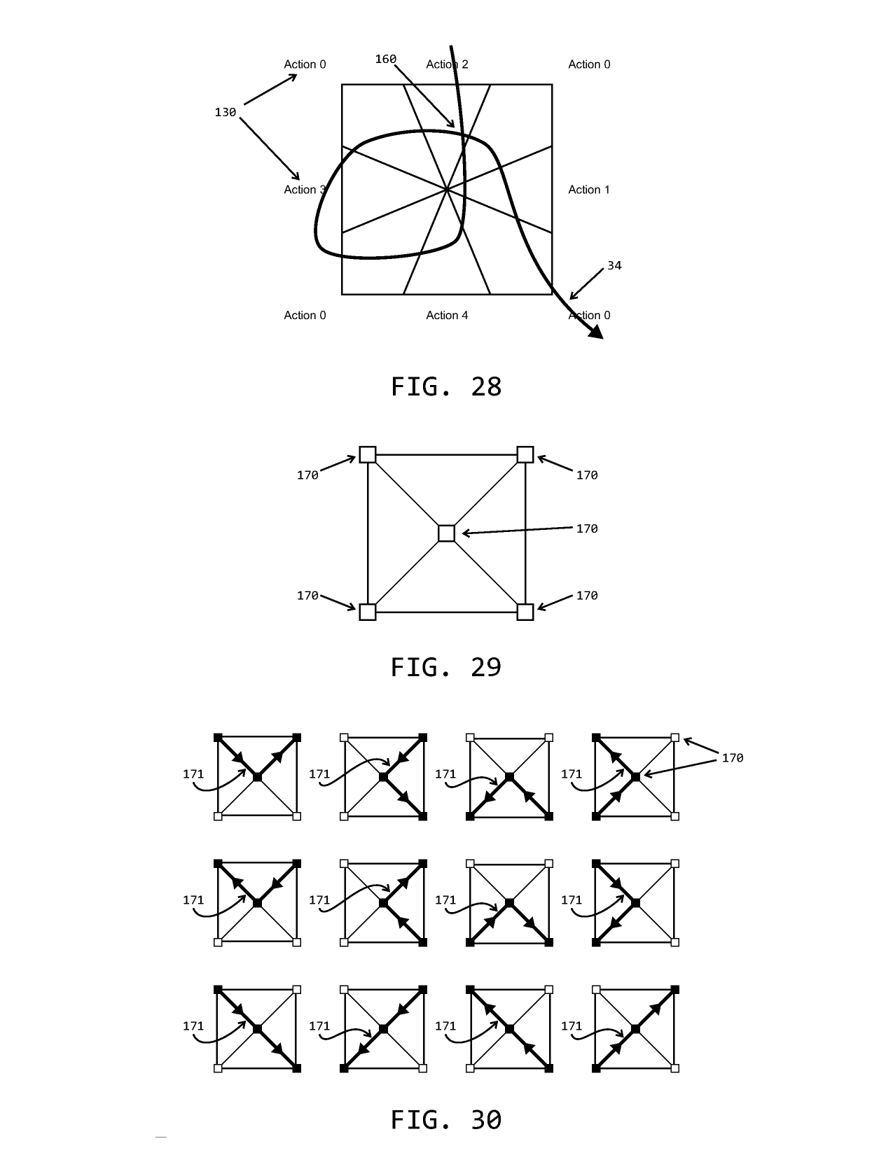

Next please refer to FIG. 28. For specificity, the description is continued in the context of the 4×3 matrix with up to five actions or alternatives associated with each of the twelve areas.

In the above description, with multiple “turn-around” selections, the user is likely to identify both the intended area as well as the desired particular action (one of up to five) associated with this area before creating a line trace describing the combined choice. It is also possible to change this combined process and break it up into two choices. First, we assume that the user looks for the area and then, second, he chooses one of the five actions. This two-step process implies that the user is not expecting to execute an action upon finding the intended area but rather execute an extra step after that. With such a process, it makes more sense to similarly first identify the area and then activate the particular selection of the five alternatives. Translated into squiggling, the user moves the fingertip into the intended area (one of the twelve) and then has access to five different ways to trigger actions.

Although the activation of a certain action is considered a two-step process, the implementation of this process is desired to be a continuous procedure without causing the user to change focus of attention. (This implementation criterion is hard to quantify and also difficult to verify if it has been satisfied.)

The following approach addresses this.

Next, please refer to FIG. 28. Suppose the user's squiggle leaves a visible line trace, possibly with finite duration either as a function of time, or of sample points (if the sample time intervals are set and fixed, then this is essentially the same as “time”), or of distance. Then the trace itself offers a dynamically defined curve segment to cross.

The user moves his fingertip until it is within the intended area. Now, to inform the underlying entry system controller that the intended area has been found, the user crosses the just-generated trace. This self-intersection is now used as the “intent indicator.”

The system is now ready to present an interface that allows the user to select one of the five alternatives. Once the self-intersection has been detected, the segmented boundary (as in FIG. 25) may be used for triggering one of the particular actions.

To make these two steps fit into a continuous process, it is noted that the user (in most cases) may continue the fingertip motion of the loop that created the self-intersection towards the exit of the appropriate portion of the boundary. To see this, assume for example that the fingertip enters the intended area through the top side; see FIG. 28. Since the intended area has been reached, the user creates a self-intersection. If the user intends to activate any of the actions besides Action 2, this can then be taken into account in the loop formation (during the creation of the self-intersection). A clockwise loop will readily allow the user to exit through the boundary associated with Actions 0, 1, 0, and 4 (essentially along the right side) with (approximately) a 360° or less direction change. Similarly, a counterclockwise loop can be used for exiting through the boundary associated with Actions 0, 3, and 0 (essentially along the left side). For Action 4, either a clockwise or a counterclockwise loop can be used with an approximately 360° direction change. In fact, only the selection of Action 2 is not immediately made part of a loop formation; see FIG. 28. This is an acceptable exception to the general loop formation; the “turn-around” is almost a complete loop as well (and sometimes results in one).

In this approach, with the use of self-intersections, it is thus quite natural to add the “turn-around” trigger for the one portion of the boundary (i.e., the entrance into the area) that is excluded from the continuous “selection of the area+selection of alternative” as just described.

Note that in FIG. 28, we have allowed the trace to leave the square; the intent indicator is the self-intersection that falls within the square. The implementation of this overall “self-intersection” approach (with or without the added “turn-around”) is somewhat more complex in that case compared to when we require the trace to stay within the square.

It may be noted that the user may easily be provided with the possibility of cancelling the selection of the area and the associated five alternatives (thus offering six alternatives, not five).

There is yet another approach, besides “turn-around” and “self-intersection” (and combinations of these) that is quite interesting. Again, for specificity, the description will be in the context of the 4×3 layout in FIG. 26.

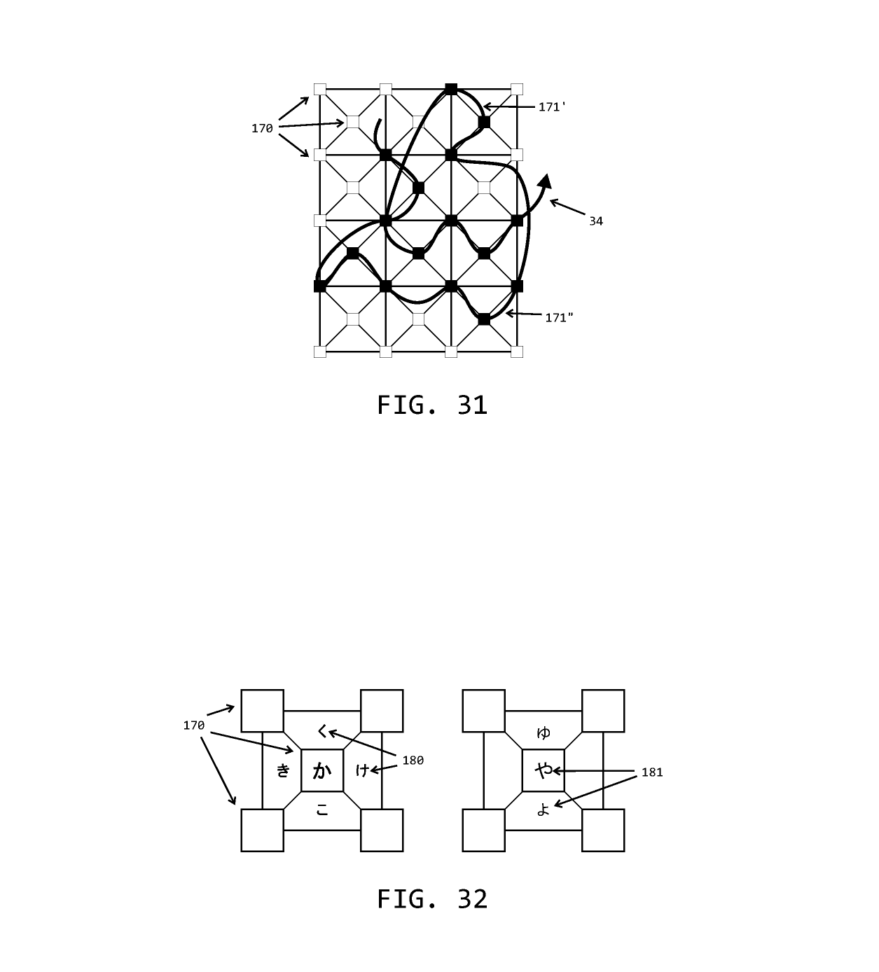

Please next refer to FIG. 29, FIG. 30, and FIG. 31. In FIG. 29, there are four little areas (similar to the core areas discussed above) at each corner of each entity in the matrix and a similar area at the center.

To execute an action associated with a given square, the user is now asked to connect three of these little squares by going through the center. Here the intent of the user is thus going to be expressed by connecting three of these little squares belonging to one of the twelve elements in the 4×3 matrix (a “direction change”). If orientation is included, there are thus twelve different connections that can be made; see FIG. 30. If all the diagonal connections (third row of FIG. 30) correspond to one action, Action 0, and the orientations for the others are ignored (so that the sequence of actions on the first row of FIG. 30 corresponds to the same action as the sequence on row two, in the same column), then there are up to five possible actions/alternatives for each square element of the matrix. In FIG. 31, this is illustrated with a line trace, using these three-point intent indicators, corresponding to 23, 34, 57, 13, 37, 42. By adjusting the size of the “little squares”, the precision of the user's movements can be adjusted (and, hence, how precisely the intent has to be indicated). As part of the implementation, it is possible to require that the trace stays within a given square once a corner square has been activated in order to trigger one of the possible three-point intent indicators.

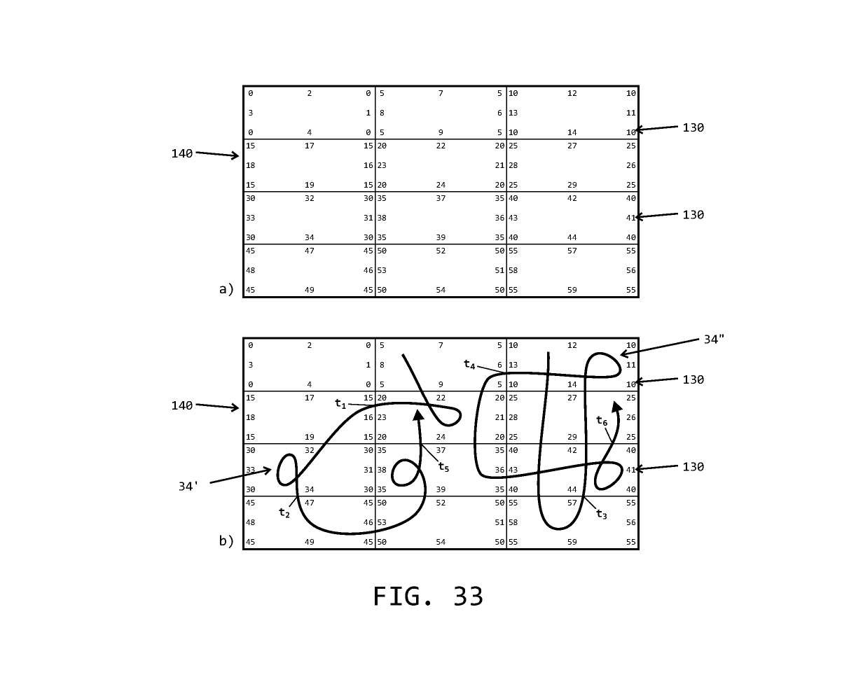

Next, FIG. 32 is considered. In this figure, the “direction-change” intent indicator is illustrated for a couple of examples of standard allocations of characters 180 and 181 used by many Japanese cellphones.

In these examples in FIG. 32, different sized “smaller” squares have been used, compared to the illustration above, to emphasize that the size of the smaller squares can be adjusted. Note that the “direction-change” indicator of intent can also be implemented as a flick; this flick is then recognized as part of an ongoing squiggle. More specifically, as the squiggle proceeds, it reaches, or starts, in a certain square (one of the twelve). Then the user may create a “V”-shaped gesture or a diagonal gesture. For example, to create a flick corresponding to starting in the top left corner, then going the center, and exiting in the upper right corner, the flick starts anywhere within one of the twelve squares. It then goes down and over by a specific amount, say at least half the side-length of this square but not more than a full side-length, both down and to the right, and then it goes up and to the right by at least half the side-length of this square but not more than a full side-length. This then completes a gesture that may replace this particular three-point connection. The other three-point connections, see FIG. 30, may similarly be replaced by flicks that are part of the squiggle.

There are several remarks to be made concerning the use of line traces for the data-entry controller in two and higher dimensions. To express intent, the use of “turn-around”, “self-intersection”, and three-point “direction change” intent indicators have been described. There are additional ways. For example, the user may move the fingertip back and forth to indicate intent. However, this back-and-forth motion likely requires a considerable interruption in the ongoing fingertip motion (arguably more substantial than the “turn-around” or “self-intersection” triggering). These different triggering options can be compared with that of a computer mouse: First, the cursor is moved to a particular desired area and then the intent is expressed by clicking a mouse key.

There are several additional points to make about the use of two-dimensional arrays or two-dimensional data in connection with the data-entry system controller described here. Instead of using a single “self-intersection”, with a loop in either the clockwise or counterclockwise direction, multiple “self-intersections” (and loops with multiple turns) may be used. This is an easy way to provide an analogue of multi-tap (and multi-cross for Squiggle). It also makes it possible to support more than eight alternatives (here associated with the eight major directions). In addition, changing the direction of the loop may be used. For example, if the original loops are clockwise, then a counterclockwise loop may undo the selection of the area or cycle backwards among the available alternatives (these alternatives may also include an “undo selection”).

Similarly, by repeatedly going through the same three-point indicator (see FIG. 30), support may be provided for an analogue of multi-tap for the “direction change” approach.

Of course, there is nothing special about the 4×3 matrix used in the descriptions above; a more general two-dimensional arrangement of areas, even of irregular shapes, may be easily supported. Similarly, to extend this approach to more than two dimensions is also straightforward as recognized by anybody of ordinary skill in the art.

To avoid accidental triggering, a core region may be added as described above in the simple case of one alternative. Further, with the approach to more than one alternative with “self-intersection” triggering supplemented with the “turn-around” trigger, the user may always move the fingertip around to be able to always rely only on the “turn-around” trigger. For example, in FIG. 28, the user may enter through an Action 0 portion of the boundary and then turn around, thus avoiding the “self-intersection” (and loop) in FIG. 28.

Another point to emphasize is that the “turn-around”, the “self-intersection” (optionally together with the “turn-around”), and “direction change” approaches of two-dimensional arrays each easily support two-handed operation. Once again, the important point, just as for regular line traces, is to keep track of the order of the triggering events. Hence, not only may a two-handed operation be used, two separate traces (one for the left hand and one for the right hand) may concurrently be generated. See FIG. 33. This is particularly relevant in landscape mode on smartphones or for tablets. In FIG. 33 a), the twelve rectangular areas are each associated with up to five actions/alternatives for a total of up to sixty. These are indicated by numbers from 0 to 59. In FIG. 33 b), two separate squiggles, one for the left hand and one for the right, are indicated using the “self-intersection” and “turn-around” triggers. The left hand squiggles the actions with numbers 23, 34, and 37; the right hand similarly squiggles 57, 13, and 42. By ordering the triggering events, the user may in this way squiggle the action sequence 23, 34, 57, 13, 37, 42. The different triggering events for this are numbered t1-t6 in FIG. 33 b).

The different line tracing approaches for two-dimensional (and higher dimensional) arrays described all share two other important features: “remote operation” and “midair operation”. In particular, the input may be provided in one place for the squiggle, and the output may occur somewhere else. This has many applications. One example of this that it easily overlooked is the following: as the user's fingertip enters one of the intended areas (i.e., one of the twelve squares in the context used above), then an area “preview” map may be provided to the user with a precise representation of the fingertip's location within the area to help the squiggling process.

And motion tracking of the appropriate feature (like a finger, fingertip, hand, IR source, magnetometers, etc.) may be used to define the input necessary for “midair” operation of squiggling.

So, as remarked above, two-handed operation, remote, and midair operation can all be used in these two-dimensional and higher-dimensional arrays and data situations. For the regular line interface, with linearly organized data, a physical grid implementation has been described; this implementation can be used to provide the user with haptic feedback. This then allows the user to enter data and commands without relying on visual feedback or at least very little visual feedback.

The different intent indicators (“turn-around”, “self-intersection”, and “direction change”) described above can be used for physical line tracing grids as well.

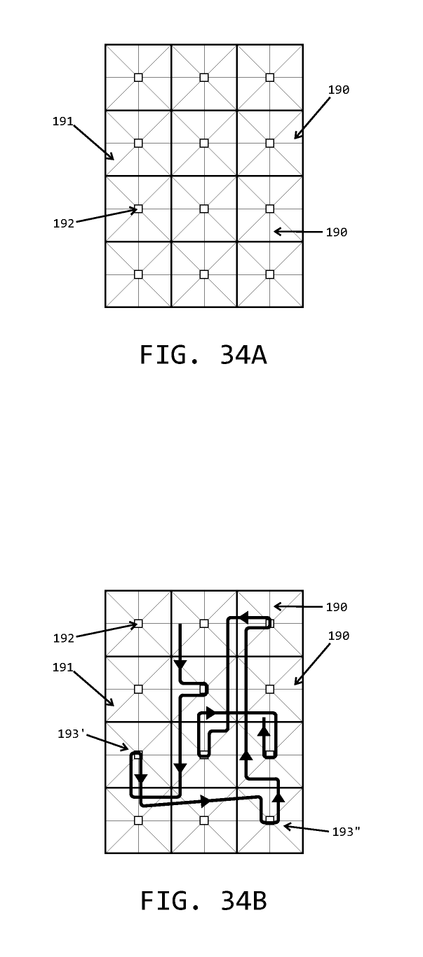

First, please refer to FIG. 34A and FIG. 34B. These illustrations involve the “turn-around” indicator approach. It is assumed then that a physical grid like in Fig. FIG. 21A is provided. This grid supports both horizontal movements as well as diagonal movements (to make it easier for the user to haptically discern where the fingertip is, ridges of different thicknesses may be used or multiple lines, etc.).

The user's fingertip is allowed to follow this physical grid with the indicated ridges.

In FIG. 34B, an example sequence of actions/alternatives using this physical grid is illustrated.

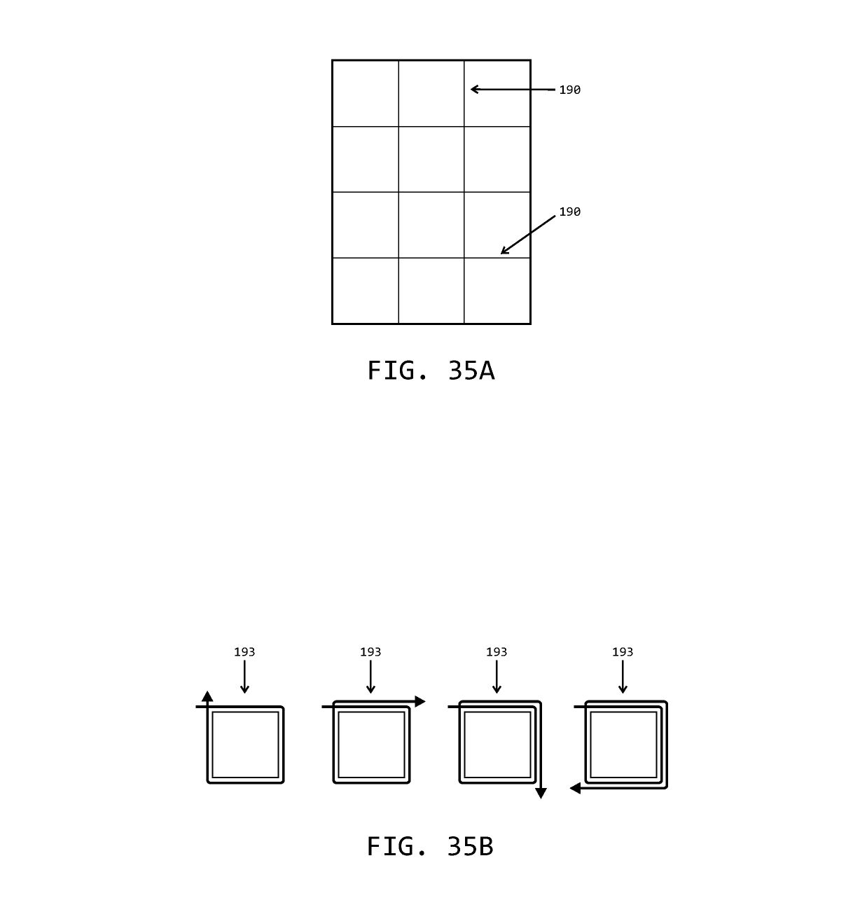

For the “self-intersection” intent indicator approach for physical grids, please refer to FIG. 35A and FIG. 35B.

The simple physical grid in FIG. 35A is the starting point.

This grid easily supports four different actions for each corner of the square basic element; see FIG. 35B. Thus there is the possibility of supporting a total of sixteen different actions with this simple physical grid. And even if the exit direction determines the action, there are still four different actions that can readily be supported. If the diagonal directions are added to the physical grid in FIG. 35A, then there is a large number of different actions that we can use this grid for. In particular, just using the exit directions and equating all the diagonal exit directions with one action, the support for five different actions for each square basic element is still maintained. (Notice that it is possible that the loop that creates the “self-intersection” may now be square-shaped or triangular-shaped.)

For the “direction-change” intent indicator, please refer to FIG. 34A and FIG. 34B. With the use of three points, a physical grid like the one in FIG. 34A may be used. With this, the same basic actions are supported; cf. FIG. 30.

In FIG. 34B, a possible way to squiggle the sequence of actions 23, 34, 57, 13, 37, and 42 is illustrated. Note that with this physical grid, the allocation of up to sixty actions as in FIG. 27A is easily accomplished; cf. FIG. 31.

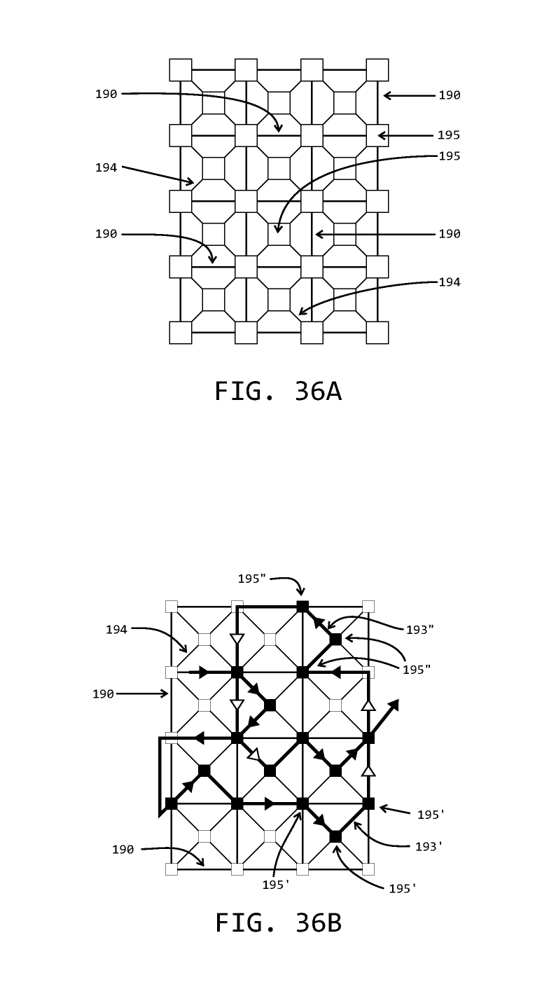

This physical grid shares several interesting features with the one used for regular squiggle. In the case of regular squiggle, horizontal motions for transport, without triggering an event, and vertical motions to trigger events were used. With the “direction-change” grid in FIG. 36A, the motions are similarly divided into two disjoint classes, but now the distinction is between motions parallel to one of the axes and motions in one of the diagonal directions. More specifically, as long as the fingertip follows a ridge that is parallel to the axes, no action is triggered and this is thus used for transport. To trigger an action, a motion along a diagonal ridge must be involved. This distinction makes it easy for the user to differentiate between simply moving the fingertip and moving it with the intent to trigger an action.

There is a lot of flexibility in designing the different ridges and intersection indicators for the various physical grids in order to provide the user with good haptic feedback. Another point to emphasize is that these grids actually do not necessarily need to be implemented physically. With the emerging new touch-screen technologies, such as the electro-tactile stimuli that generate tactile/haptic feelings (cf. the Tixel technology by Senseg), the haptic feedback that physical grids afford may also be provided by a “virtual” grid. Such a “virtual” grid can be presented to the user on an ad-hoc basis when it is needed. In particular, the grid may change shape depending on the application. Hence, Squiggle, both its regular and higher-dimensional versions, can be implemented using such “virtual grids”.

The data-entry system controller described relies on the line trace crossings of a main line equipped with line segments associated with characters and actions. It is also possible to implement the basics of this data-entry system that instead relies on a touch-sensitive physical grid; this physical grid provides the user with tactile feedback. This has the advantage that the user obtains tactile feedback for an understanding of his fingertip location on the grid. By moving his fingertip along this grid, he is able to enter data, text, and commands while getting tactile feedback almost without visual feedback. To complement the visual feedback, audio feedback may also be provided with suggestions from the data-entry system controller concerning suggested words and available alternatives, characters, etc.

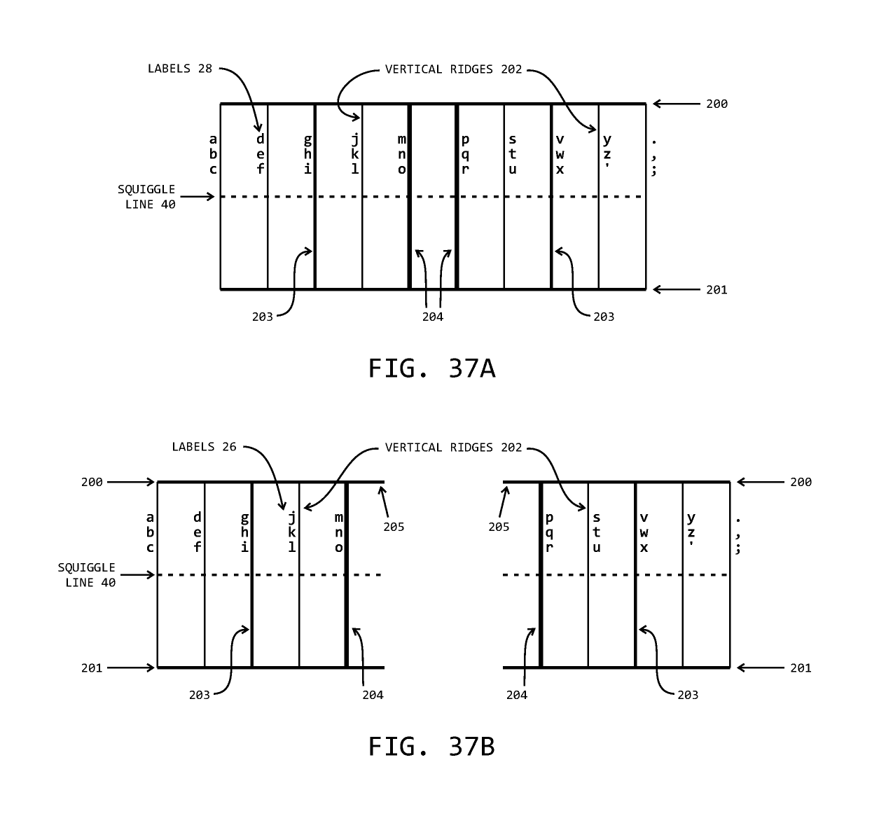

For the description of such a physical grid implementation, please refer first to FIG. 37A. It is also useful to contrast this with the regular line tracing as described in, for instance, FIG. 6.

Regular line tracing, as described above, registers the crossing events and associates these with the input of (collections of) characters and actions. Between crossings, the line trace is simply providing transport without any specific actions.

The touch-sensitive physical grid replaces this transport by the user sliding his fingertip along horizontal ridges 200 and 201. Similarly, it replaces the crossing points by the fingertip traversing completely from one horizontal ridge to another physical ridge along a vertical ridge 202, 203, or 204. In this way, a one-to-one correspondence is established between the line trace crossing events (in the case of the regular line tracing) and the complete traversals of specific vertical ridges (in the case of tracing along the physical grid).

Hence, any particular line trace, and its corresponding crossings (for the regular data-entry system controller described above) may be described in terms of tracing of such a physical grid of horizontal and vertical ridges.

To improve the haptic and tactile feedback to the user, it is possible to adjust the physical ridges in several ways. For example, different thicknesses of these ridges may be provided to help the user understand where his fingertip is located on the grid; cf. the vertical ridges 203 and 204 as well as the horizontal ridges 200 and 201. Similarly, differently shaped intersection points between horizontal and vertical ridges may be provided.

Such a touch-sensitive grid can be put in many places to obtain a data-entry system. For example, it may be implemented on a very small touchpad or wearable. To further extend the this flexibility, the grid can be divided into several parts. In FIG. 37B, for example, a grid for two-handed operation is described. In this case, there is a left part and a right part, one for each hand. In addition, rather than just dividing the grid in FIG. 37A in two, each of the smaller grids in FIG. 37B is provided with extensions 205. These extensions make it easy for the operation of the left thumb, say, to be continued by the right thumb. To enter data (text, actions, etc.), the user lets the thumbs slide against the horizontal ridges 200 and 201; to execute an entry event, one of the thumbs slides over one of the vertical ridges. Notice that the set of characters and actions 26 represented by vertical ridges 202, 203, and 204 depends on the particular application. Essentially, any ordering (alphabetical, QWERTY, numeric, lexicographical, etc.) may be used as well as any groups of characters and actions.

Further, the basic grid of FIG. 37A and FIG. 37B may be complemented with similar grids for control actions (mode switches, edit operations, space and backspace, etc.).

As one of ordinary skill in the art will recognize, the physical grid can be implemented with curved rather rather than strict horizontal and vertical ridges. The number of vertical ridges can also be adjusted to suit a particular application. The roles of the horizontal and vertical ridges may be switched. In this way we obtain an implementation for vertical operation. The underlying surface is also very flexible; for example, the grid can be implemented on a car's steering wheel or on its dashboard.

Notice also that with such a physical grid, just as for the system in FIG. 6, it may be advantageous to provide the user with audio feedback about the generated activities (including entered words and related word suggestions), rather than only using visual feedback.

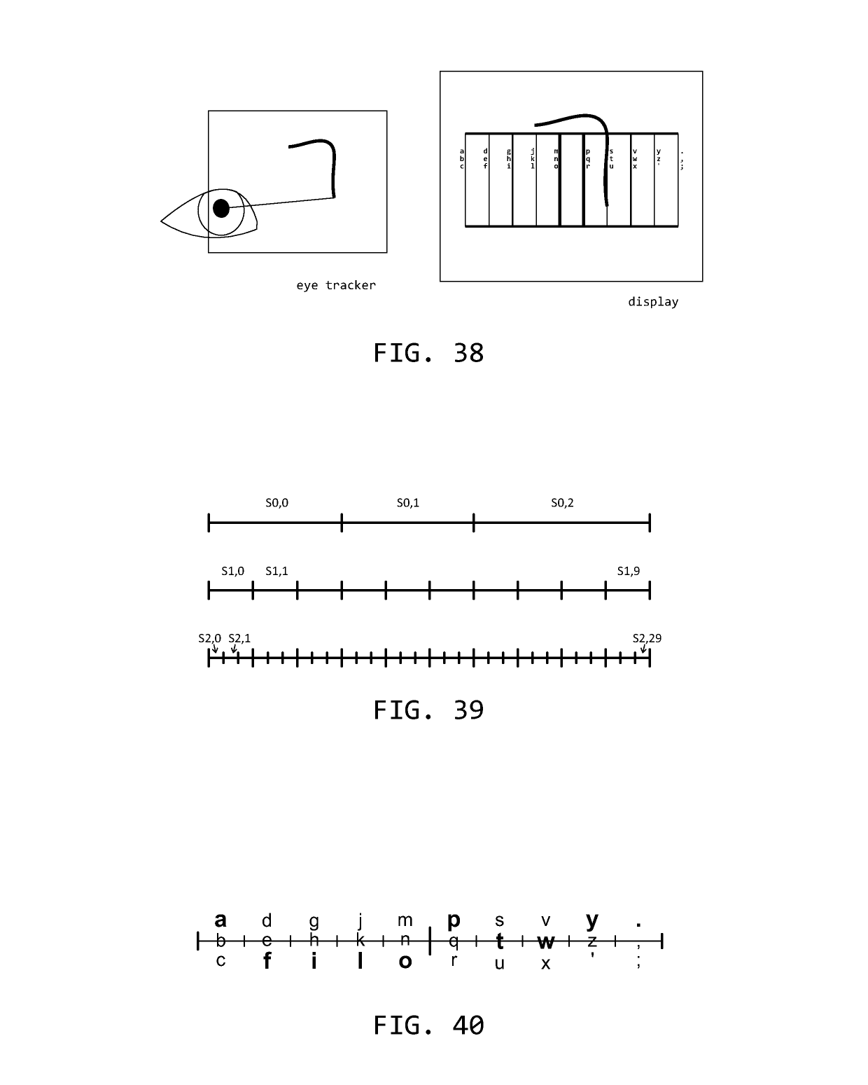

The basic idea of the physical grid implementation, cf. FIG. 37A and FIG. 37B, also makes another implementation possible. For this, please refer to FIG. 38. The acquisition of coordinates of the line trace 34 may be obtained by tracking the movements of the user's eyes (or pupils). This then makes it possible to implement a data-entry system controller relying on eye movements to control the line trace. The user interface for such an application implementation makes it easy for the eyes to move to a certain desired group of characters or actions along a horizontal line presented on a remote display. Once the eye has moved to the desired group along the horizontal line, the eye may move along the vertical line for this particular group. A “crossing” event is registered when the eye completes the movement along a vertical line, from one horizontal line to the other. The horizontal and vertical lines are designed to make it easy for the user to identify the different groups of characters and actions without letting the eyes wander to unintended locations.

Just as in the case of the midair operation, the user interface for this eye-tracking implementation may be complemented with horizontal and vertical lines for added control functionality (like “backspace”, mode switches, “space”, etc.). To stop and start the tracing generated by these eye movements, the interface may be provided with a bounding box, for example. When the eyes are detected to be looking inside the box, the tracing is active, and when the eyes leave the box, the tracing is turned off.

Recently, there has been a surge of interest in so-called wearables, such as watches. This is probably due to the availability of small touchscreens, powerful processors, and suitable operating systems that support a spectrum of quite advanced features on such small devices. As these small, capable devices reach the market, users are demanding more and more services. A fundamental problem in connecting to the internet, and applications that rely on the internet, is that these connections often require both passwords and URLs. Since these types of character combinations are likely to be irregular and difficult to predict, predictive text-entry systems are often not suitable for entering such strings. So, entering passwords and URLs on small-form-factor devices poses a particularly significant challenge since there is little room for conventional virtual keyboards.

Similarly, wearables often appeal to joggers, bikers, and others pursuing active recreational sports. For this target market, it is often of great interest to enter street names, another class of character combinations where prediction-based approaches often fail and need to be addressed in other ways.

When it comes to entering passwords and other combinations where prediction is of little value, FIG. 39 and FIG. 40 illustrate two different approaches.

One simple, non-predictive approach is to use more than one level for the line trace (for “squiggling”). The first level looks the same as that used by standard Squiggle for predictive text- and data-entry; see FIG. 2A.

Multi-level line tracing uses additional levels to resolve the ambiguities resulting from assigning multiple characters to the same crossing segment.

Suppose there are only three segments on the basic line 40:

### S0,0=qaz wsx edc

### S0,1=rfv tgb yhn

S0,2=ujm Ik, ol. p;′

So, these three segments (essentially) correspond to the left, middle, and right portions of a standard QWERTY keyboard. On a second level, these larger groups are further resolved into those used by the embodiment illustrated in FIG. 2A:

| | | | |
|---|---|---|---|
| S1,0 = q a z | S1,1 = w s x | S1,2 = e d c | |
| S1,3 = r f v | S1,4 = t g b | S1,5 = y h n | |
| S1,6 = u j m | S1,7 = i k, | S1,8 = o l. | S1,9 = p;’ |

Hence, there are only three segments on the top level and a variable number on the next level, but at most four segments.

Of course, in this example, it is possible to introduce yet another level to completely resolve the characters:

| | | | |
|---|---|---|---|
| S2,0 = q | S2,1 = a | S2,2 = z | S2,3 = w |
| S2,4 = s | S2,5 = x | S2,6 = e | S2,7 = d |
| S2,8 = c | S2,9 = r | S2,10 = f | S2,11 = v |
| S2,12 = t | S2,13 = g | S2,14 = b | S2,15 = y |
| S2,16 = h | S2,17 = n | S2,18 = u | S2,19 = j |
| S2,20 = m | S2,21 = i | S2,22 = k | S2,23 = , |
| S2,24 = o | S2,25 = l | S2,26 = . | S2,27 = p |
| S2,28 = ; | S2,29 = ‘ | | |

A more geometrical representation of this organization is in FIG. 39.

Note that the number of segments on each level is small: on level 0 there are three segments; on level 1 there are three or four; and on level 2 there are three segments.

If the width of the screen on which these segments are to be placed is small, then these segments may still be quite long.

Of course, in the above description, the QWERTY ordering of the relevant characters (like the letters, numbers, and standard symbols) plays no particular role. Hence, other orderings may be used.

Another simple and more direct approach to non-predictive text entry is to use an analog of traditional multi-tap (where a key on a keyboard is tapped repeatedly to cycle through a set of characters associated with the specific key). In this approach, a single crossing of a certain segment brings up one of the characters in a group of characters or actions associated with the segment. A second crossing immediately thereafter brings up a second character in the group, and so on. When the group is exhausted, an additional crossing returns to the first character in the group (“wrapping”). Hence, this approach relies on a certain ordering of the characters in each group associated with the different segments. This ordering may simply be the one used by the labels displaying the characters in a group.

Just as in the case of multi-tap, a challenge is how to enter double letters and, more generally, consecutive characters that originate from the same segment. In the case of the standard multi-tap approach (used on many older cellphones with numeric keypads, for example), a certain time interval is commonly used: after the particular time has elapsed, the system moves the insertion point forward and a second letter can be entered.

Instead of relying on such a time interval, the line tracing data-entry system controller described here may rely on the user moving the fingertip away (either to the left or to the right) from the vertical strip directly above and below the line segment that needs to be crossed again for a double letter or for another character from the same group of characters or actions. Alternatively, the user may move the fingertip away in the vertical direction by a pre-established amount (for example, to the upper and lower control lines in FIG. 16A) to move on to the next character in the same group.

For passwords, URLs, and email addresses there is little need for the space character. Hence, it is also possible to change the interpretation of leaving the touch-sensitive surface to instead mean “move to the next character”/“move the insertion point forward”.

The multi-cross line tracing has the advantage that any character combination may be entered without regard for the vocabulary or dictionary in use. Next, a “hybrid” predictive approach based on the same basic ideas as the just-described multi-cross line tracing is described, but this time relying on an underlying dictionary or vocabulary. In contrast to most predictive text-entry approaches, this “hybrid” approach may be used to enter any character combination, not just the ones corresponding to combinations (typically “words”) in the dictionary or part of the vocabulary. This approach is thus a hybrid between a predictive and non-predictive technique.

When using multi-cross line tracing, as described above, for a character combination associated with a password, for example, it is a reasonable assumption that the characters in a certain group of characters are distributed with a uniform, random distribution. Under such an assumption, and using the groupings depicted in FIG. 2A and FIG. 16A, for instance, it is expected that the line 40 is crossed on the average two times for each character that is entered. This is obviously more crossings than when using a predictive disambiguation and error module for resolving what character is intended for a particular crossing of the main line. However, if the intended character combination falls outside of the dictionary in use by such a predictive module, then an advantage of the multi-cross line tracing is that the combination may be immediately entered. This is an advantage that the “hybrid” approach described here will maintain. The average number of crossings will still be very close to one.

Please now refer to FIG. 40. To simplify the presentation, the assumption is made that characters are entered from left to right and also that the characters and groupings are based on an alphabetical ordering. Further, another assumption is made that there is an active dictionary defining a vocabulary of valid words with probabilities of each word. From this dictionary, it is possible to derive a so-called Beginning-Of-Word dictionary (BOW dictionary) where each BOW has a probability. This is described in detail in the U.S. Pat. No. 8,147,154 “One-row keyboard and approximate typing”.

Let us now say that user wants to enter a new character combination. So, to the left of the current insertion point there is a “beginning of file”, “space”, or other delimiter (collectively referred to as “beginning-of-word indicator”) to signal that a new word is about to be started. Each of the nine groups now has a most likely next character that forms the beginning of a word (based on the BOW dictionary corresponding to the dictionary in use). In fact, within each group of three, there is an ordering of the characters in decreasing (BOW) probability order:

| | | | | | | | | | |
|---|---|---|---|---|---|---|---|---|---|
| Group | a | d | g | j | m | p | s | v | y |
| | b | e | h | k | n | q | t | w | z |
| | c | f | i | l | o | r | u | x | |
| BOW probability | a | f | i | l | o | p | t | w | y |
| order (decreasing) | c | d | h | j | m | r | s | v | z |
| | b | e | g | k | n | q | u | x | |

For the “hybrid” approach, the labels 28 are used to indicate which one of the three characters in each group that will be the most first character to use upon a crossing (the “entry point” into the particular group). Using the (BOW) probability ordering, this first character will be the most likely beginning of a word, and the user is notified about this choice of character upon the first crossing by, for example, changing the color of this character (or in a number of different ways). Then we cyclically shift the ordering of the group. In this way, we can leave the same graphics on the keys, except for the change of color (or similar).

For example, of the characters “a”, “b”, and “c”, the most likely to start a word is “a”; among the group “d”, “e”, and “f”, the most likely to start a word is “f”, and so on; please see the table above. So with the “hybrid” approach the labels 28 are presented as in FIG. 40 (or similar).

If the user now decides to cross the [abc] segment, then he will need only one crossing to reach “a” and then with two crossings he reaches “c” and then, with another one, “b”.

The user is assumed to cross the appropriate segment until the desired character has been selected before continuing to the next character.

Now the system is ready to consider the entry of the next character. This character can simply be a space (or other delimiter) to indicate that a word (from the dictionary) has been reached (collectively referred to “the end-of-word indicator”). It may also be another letter among the nine groups in use. If it is a space character, then it is typically assumed that this information is non-ambiguously entered by the user (possibly through pressing a dedicated key or crossing a segment corresponding to “space”) and interpreted by the controller. For the other characters among the nine groups, the just-described procedure is repeated. More specifically, the system figures out the ordering to use within each of the nine groups based on the beginning-of-word indicator and the prior character. For each of the characters in the nine groups, the system may find (or already have access to in a look-up table) the probability of the BOW corresponding to the first character entered followed by any specific character from each of the nine groups. This then allows the system to display this information to the user by color-coding or boldfacing or other method, similar to Fig.

For example, suppose the user selected the first character “t”. For the next character, and using the beginning-of-word indicator and this prior “t”, the characters in each of the nine groups has the following ordering (using the BOW probability) in a standard vocabulary.

| | | | | | | | | | |
|---|---|---|---|---|---|---|---|---|---|
| Group | a | d | g | j | m | p | s | v | y |
| | b | e | h | k | n | q | t | w | z |
| | c | f | i | l | o | r | u | x | |
| BOW probability | a | e | h | l | o | r | u | w | y |
| order (decreasing) | b | f | i | j | m | p | t | v | z |
| | c | d | g | k | n | q | s | x | |

So, for example, after a “t” has been entered, the most likely beginning of a word using the group [tuv] is “tu” followed by “tt” (in the case of the vocabulary used here).

With the hybrid approach, the letter “h” is indicated through a color change (or similar) in the [ghi] group.

To continue to additional characters (third, fourth, etc.) if necessary, the data-entry system controller continues by induction in the same fashion until the end-of-word indicator is reached. Of course, when the end-of-word indicator is reached, the system is ready to restart the process.

As anyone of ordinary skill in the art will recognize, the orderings within each of the groups of characters may change, and not just moving one of the characters to the top priority to be used by the next crossing of that particular line segment.

There is always the possibility that the user has entered characters that will result in no valid BOW-based prediction for some, or perhaps even all, of the groups of characters for the different segments. When the user in this way “leaves” the dictionary, this BOW prediction method may use several different approaches to decide upon the ordering of the characters of the different groups. The system may, for example, switch to a segment-by-segment prediction and just rearrange the order of the characters within the relevant groups. Alternatively, the system may use one or several of the characters already entered even though there is no word in the dictionary that now is a target. An N-gram approach (for N=0, 1, or higher) is one such possibility. The information about these N-grams may be calculated beforehand. And here as well, there are many other possibilities.

In the description above, BOW probabilities have been used to predict the next character, and the display of labels is based on this. Notice that the basic procedure described above does not depend on the BOW prediction method (many variations and improvements of which can be found in U.S. Pat. No. 8,147,154); essentially any prediction method that uses the already entered characters to predict the current one, or, more precisely, the ordering within each of the groups of letters, can be used instead.

For example, instead of using all of the previous characters, we may decide to use just the immediately prior one. We may then decide to avoid the dictionary entirely and use probabilities from the entire vocabulary. In other words, it is possible to use a simple transition matrix giving the probabilities of a specific character given a prior character (including the beginning-of-word indicator).

Similarly, without having to use a dictionary, it is possible to use the ordering based on two or, more generally, N previous characters (N+1 gram models), to make predictions.

These possibilities represent different embodiments of the same basic data system controller.

In the BOW prediction method described above, the role of the dictionary is primarily to generate the ordering of the characters for the different segments. Hence, the dictionary is only used to provide the BOWs and their probabilities, and these in turn are only used to obtain the character orderings for the different segments. In other words, as long as there is a way of obtaining an ordering for the different segments as the user enters characters, then there is no use of the dictionary per se. (Of course, the dictionary may be useful for many other reasons like spell-checking, error corrections, auto-completions, etc.)

With any of these prediction methods, as long as the prediction generates a more accurate choice than just a random selection, the average number of necessary crossings will be reduced.

In the case of the BOW prediction method, the system quickly reaches a point where the word is quite accurately predicted. At that point, the system may present the user with “auto-completion” suggestions. The system may then also start displaying the “next character” with great accuracy to the user, thus requiring only one crossing with similar great accuracy.

Another comment about the BOW prediction method is in order. There are several very efficient ways to find (and also store the relevant information for) the orderings of the characters needed for the different segments. One way is to use look-up tables for some of this. For the first couple of entered characters this is completely straightforward. In the example of the alphabetical ordering, which has been used here for illustration, there are 26 characters to consider. So, given the first character, say, there are 26×26=676 possible two-letter combinations. It is easy to check the (BOW) probability of each one among the vocabulary in use. Upon such a check, a reduced number of valid BOWs are available; the remaining character combinations do not correspond to any BOWs of the vocabulary in use. Similarly, assume that two characters (from the set of 26 characters) have been entered; then there are 263=17,576 possible combinations. Of these, only a smaller set are valid BOWs derived from the vocabulary in use. As more and more characters are considered, the valid BOWs quickly become a small percentage of all the possible combinations. This means, for example, that it is possible to quickly reduce the number of BOWs that must be considered when using the BOW prediction method.

When more characters are considered, then to consider all possible combinations easily becomes prohibitive.

In this case, the BOWs may be calculated on-the-fly from the dictionary by using location information in the dictionary to find blocks of valid BOWs as described in U.S. Pat. No. 8,147,154 “One-row keyboard and approximate typing”.

Another way to deal with the sparse information of valid BOWs is to use the tree structure of the BOWs. Since a BOW of length N+1 corresponds to exactly one BOW of length N (N≧0) if the last character is omitted, the BOWs form a tree with 26 different branches on each level of the tree. This tree is very sparse.

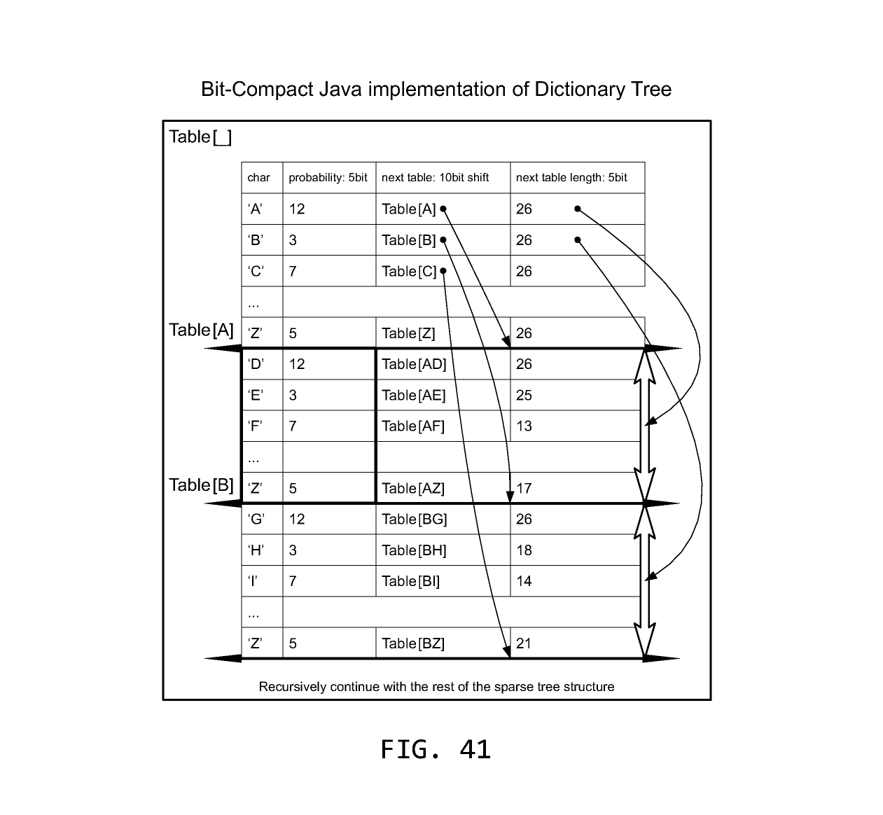

The tables with the BOW probability information for each BOW length (i.e., at each level of the tree) may be efficiently stored. For example, after entering say three characters, it is possible to provide 3,341 tables with such probabilities, one for each of the 3,341 valid BOWs, and for the system controller to calculate the ordering of each of the groups needed before entering the fourth character. These tables can be calculated offline and supplied with the application; they can also be calculated upon application start-up, or on-the-fly. There are several other efficient ways to provide the sparse BOW probabilities and ordering information for the different groups. The basic challenge here is to make the representation of the information both sparse and quick to search through and retrieve how to order the characters for the different segments as the user proceeds with entering characters. A description of such a representation is given in FIG. 41.

In the above description, handling of common punctuation marks has not yet been described. These marks can be handled by the predictive text module (used for disambiguation and error correction) as in the case of the regular line tracing (using, for example, the approach of U.S. Pat. No. 8,147,154 “One-row keyboard and approximate typing”).

The data entry system controllers and/or data entry systems according to embodiments disclosed herein may be provided in or integrated into any processor-based device or system for text and data entry. Examples, without limitation, include a communications device, a personal digital assistant (PDA), a set-top box, a remote control, an entertainment unit, a navigation device, a fixed location data unit, a mobile location data unit, a mobile phone, a cellular phone, a computer, a portable computer, a desktop computer, a monitor, a computer monitor, a television, a tuner, a radio, a satellite radio, a music player, a digital music player, a portable music player, a video player, a digital video player, a digital video disc (DVD) player, and a portable digital video player, in which the arrangement of overloaded keys is disposed or displayed.

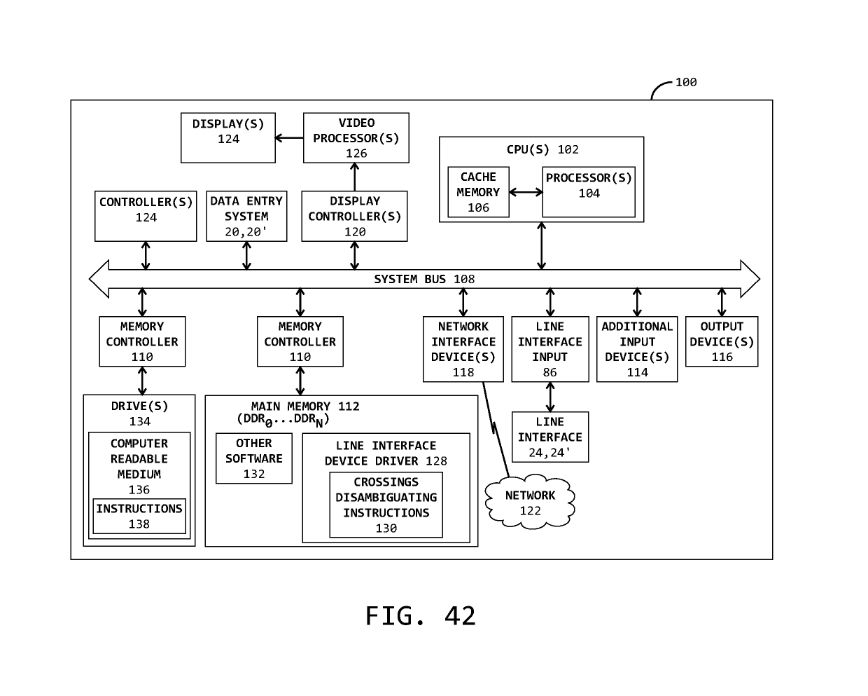

In this regard, FIG. 42 illustrates an example of a processor-based system 100 that may employ components described herein, such as the data entry system controllers 32 and/or data entry systems 20, 20′ described herein. In this example, the processor-based system 100 includes one or more central processing units (CPUs) 102 each including one or more processors 104. The CPU(s) 102 may have cache memory 106 coupled to the processor(s) for rapid access to temporarily stored data. The CPU(s) 102 is coupled to a system bus 108, which intercouples other devices included in the processor-based system 100. As is well known, the CPU(s) 102 communicates with these other devices by exchanging address, control, and data information over the system bus 108. For example, the CPU(s) 102 can communicate memory access requests to external memory via communications to a memory controller 110.

Other master and slave devices can be connected to the system bus. As illustrated in FIG. 42, these devices may include a memory system 112, one or more input devices 114, one or more output devices 116, one or more network interface devices 118, and one or more display controllers 120, as examples. The input device(s) 114 can include any type of input device, including but not limited to input keys, switches, voice processors, etc. The output device(s) 116 can include any type of output device, including but not limited to audio, video, other visual indicators, etc. The network interface device(s) 118 can be any device configured to allow exchange of data to and from a network 122. The network 122 can be any type of network, including but not limited to a wired or wireless network, private or public network, a local area network (LAN), a wide local area network (WLAN), and the Internet. The CPU(s) 102 may also be configured to access the display controller(s) 120 over the system bus 108 to control information sent to one or more displays 124. The display controller(s) 120 sends information to the display(s) 124 to be displayed via one or more video processors 126, which process the information to be displayed into a format suitable for the display(s) 124. The display(s) 124 can include any type of display, including but not limited to a cathode ray tube (CRT), a liquid crystal display (LCD), a light-emitting diode display (LED), a plasma display, etc.

In continuing reference to FIG. 42, the processor-based system 100 may provide a line interface 24, 24′ providing line interface input 86 to the system bus 108 of the electronic device. The memory system 112 may provide the line interface device driver 128. The line interface device driver 128 may provide line interface crossings disambiguating instructions 90 for disambiguating overloaded keypresses of the keyboard 24, 24′.

The memory system may also provide other software 132. The processor-based system 100 may provide a drive(s) 134 accessible through a memory controller 110 to the system bus 108. The drive(s) 134 may comprise a computer-readable medium 96 that may be removable or non-removable.

The line interface crossings disambiguating instructions may be loadable into the memory system from instructions of the computer-readable medium. The processor-based system may provide the one or more network interface device(s) for communicating with the network. The processor-based system may provide disambiguated text and data to additional devices on the network for display and/or further processing.

The processor-based system may also provide the overloaded line interface input to additional devices on the network to remotely execute the line interface crossings disambiguating instructions. The CPU(s) and the display controller(s) may act as master devices to receive interrupts or events from the line interface over the system bus. Different processes or threads within the CPU(s) and the display controller(s) may receive interrupts or events from the keyboard. One of ordinary skill in the art will recognize other components that may be provided by the processor-based system in accordance with FIGS. 2A and 2B.

The various illustrative logical blocks, modules, and circuits described in connection with the embodiments disclosed herein may be implemented or performed with a processor, a digital signal processor (DSP), an Application Specific Integrated Circuit (ASIC), a field programmable gate array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flowchart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A data entry system controller configured to:
receive coordinates representing locations of user input relative to a user interface, the user interface comprising a line interface comprising a plurality of ordered line segments, each of the plurality of line segments representing at least one action visually represented by at least one label;
determine a line trace between a plurality of coordinates crossing at least two line segments of the plurality of line segments, each of the plurality of coordinates representing a location of user input relative to the line interface;
determine an ordered plurality of actions based on the ordered crossings of the line trace with the plurality of line segments of the line interface;
determine at least one user feedback event based on the determined ordered plurality of actions; and
generate at least one user feedback event on a graphical user interface based on the executed ordered plurality of actions.

2. The data entry system controller of claim 1, wherein the plurality of line segments are comprised of a plurality of connected line segments.

3. The data entry system controller of claim 1 further configured to receive coordinates representing locations of user input relative a mirror line interfaces disposed about the line interface, each of the mirror line interfaces comprising a plurality of ordered mirror line segments, each of the plurality of mirror line segments representing at least one mirror line action visually represented by at least one label.

4. The data entry system controller of claim 3 further configured to receive the coordinates representing locations of user input relative the mirror line interfaces subsequent to receiving the coordinates representing locations of the user input relative to the line interface.

5. The data entry system controller of claim 3 further configured to apply the at least one mirror line action to the at least one of the action.

6. The data entry system controller of claim 3, wherein the plurality of mirror line segments representing at least one mirror line action comprised of at least one of a shift action, an upper case action, caps lock action, tab action, alternative action, and control action.

7. The data entry system controller of claim 1 configured to generate the at least one user feedback event on a graphical user interface distinct from the user interface, based on the executed ordered plurality of actions.

8. The data entry system controller of claim 1 configured to receive the coordinates representing locations of the user input relative to a mid-air user interface, the mid-air user interface comprising a mid-air line interface comprising a plurality of mid-air ordered line segments, each of the plurality of mid-air line segments representing at least one action visually represented by at least one label on the graphical user interface distinct from the user interface.

9. The data entry system controller of claim 1 configured to receive the coordinates representing locations of the user input relative to a touch-sensitive user interface, the touch-sensitive user interface comprising a touch-sensitive line interface comprising a plurality of ordered line segments, each of the plurality of line segments representing at least one action visually represented by at least one label on the graphical user interface distinct from the user interface.

10. The data entry system controller of claim 1 configured to receive the coordinates representing locations of user eye movement input relative to the user interface.

11. The data entry system controller of claim 1 further configured to determine an ordered plurality of actions based on the ordered re-crossings of the line trace with the plurality of line segments of the line interface.

12. The data entry system controller of claim 1 configured to:
receive the coordinates representing locations of user input relative to a user interface, the user interface comprising a grid interface comprising a plurality of ordered grid line segments, each of the plurality of grid line segments representing at least one action visually represented by at least one label;
determine a grid line trace between a plurality of coordinates crossing at least two grid line segments of the plurality of grid line segments, each of the plurality of coordinates representing a location of user input relative to the grid line interface; and
determine the ordered plurality of actions based on the ordered crossings of the grid line trace with the plurality of grid line segments of the grid line interface.

13. The data entry system controller of claim 1 configured to receive the coordinates representing locations of user input relative to the user interface in multi-dimensional space, the user interface comprising a plurality of line interfaces each comprising a plurality of ordered line segments, each of the plurality of line segments representing at least one action visually represented by at least one label;
determine the line trace between the plurality of coordinates crossing the at least two line segments of the plurality of line segments between the plurality of line interfaces, each of the plurality of coordinates representing a location of user input relative to the plurality of line interfaces; and
determine the ordered plurality of actions based on the ordered crossings of the plurality of line traces with the plurality of line segments of the plurality of line interfaces.

14. The data entry system controller of claim 1 configured to determine the line trace between the plurality of coordinates having multiple crossings of the at least two line segments of the plurality of line segments between the plurality of line interfaces, each of the plurality of coordinates representing a location of user input relative to the plurality of line interfaces.

15. The data entry system controller of claim 1 further configured to determine the at least one user feedback event by predictively disambiguating the determined ordered plurality of actions.

16. The data entry system controller of claim 1, wherein each of the plurality of line segments of the line interface represent at least one key character.

17. The data entry system controller of claim 16, wherein the at least one key character is comprised of at least one of: an alphabetical overloaded key, a numerical key, a key of a QWERTY keyboard, an overloaded key, alphabetical overloaded key, numerical overloaded key, injectively-overloaded key, alphabetical injectively-overloaded key, numerical injectively-overloaded key, alphabetical injectively-overloaded key of a QWERTY keyboard.

18. The data entry system controller of claim 1 integrated into a steering wheel.

19. The data entry system controller of claim 1, further comprising a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player, into which the data entry system controller is integrated.

20. A method of generating user feedback events on a graphical user interface, comprising: receiving coordinates at a data entry system controller representing locations of user input relative to a user interface, the user interface comprising a line interface comprising a plurality of ordered line segments, each of the plurality of line segments representing at least one action visually represented by at least one label;
determining a line trace between a plurality of coordinates crossing at least two line segments of the plurality of line segments, each of the plurality of coordinates representing a location of user input relative to the line interface;
determining an ordered plurality of actions based on the ordered crossings of the line trace with the plurality of line segments of the line interface;
determining at least one user feedback event based on the determined ordered plurality of actions; and
generating at least one user feedback event on a graphical user interface based on the executed ordered plurality of actions.

21. A non-transitory computer-readable having stored thereon computer-executable instructions to cause a processor to implement a method comprising:
receiving coordinates at a data entry system controller representing locations of user input relative to a user interface, the user interface comprising a line interface comprising a plurality of ordered line segments, each of the plurality of line segments representing at least one action visually represented by at least one label;
determining a line trace between a plurality of coordinates crossing at least two line segments of the plurality of line segments, each of the plurality of coordinates representing a location of user input relative to the line interface;
determining an ordered plurality of actions based on the ordered crossings of the line trace with the plurality of line segments of the line interface;
determining at least one user feedback event based on the determined ordered plurality of actions; and
generating at least one user feedback event on a graphical user interface based on the executed ordered plurality of actions.

22. A data entry system, comprising:
a user interface configure to receive user input relative to a line interface comprising a plurality of ordered line segments, each of the plurality of line segments representing at least one action visually represented by at least one label; and
a coordinate-tracking module configured to detect user input relative to the user interface, detect the locations of the user input relative to the user interface, and send coordinates representing the locations of the user input relative to the user interface to a controller;
the controller configured to:
receive the coordinates representing the locations of the user input relative to the user interface,
determine a line trace between a plurality of coordinates crossing at least two line segments of the plurality of line segments, each of the plurality of coordinates representing a location of user input relative to the line interface;
determine an ordered plurality of actions based on the ordered crossings of the line trace with the plurality of line segments of the line interface;
determine at least one user feedback event based on the determined ordered plurality of actions; and
generate at least one user feedback event on a graphical user interface based on the executed ordered plurality of actions.

23. The data entry system claim 22, wherein the user interface is comprised of a mid-air interface configure to receive user input relative to a mid-air line interface comprising a plurality of mid-air ordered line segments, each of the plurality of mid-air line segments representing at least one action visually represented by at least one label.

24. The data entry system controller of claim 22, wherein the user interface is comprised of a touch-sensitive user interface, the touch-sensitive user interface comprising a touch-sensitive line interface comprising a plurality of ordered line segments, each of the plurality of line segments representing at least one action visually represented by at least one label on the graphical user interface distinct from the user interface.
